(19) United States
(12) Patent Application Publication
(10) Pub. No.: US 2026/0351451 A1
(43) Pub. Date: Nov. 5, 2026

(54) SOFT MAGNETIC METAL RIBBON, MAGNETIC CORE, AND MAGNETIC DEVICE

(71) Applicant: TDK Corporation, Tokyo (JP)

(72) Inventors: Takuya TSUKAHARA, Tokyo (JP); Yuta NAKAGAWA, Tokyo (JP); Akito HASEGAWA, Tokyo (JP)

(73) Assignee: TDK Corporation, Tokyo (JP)

(21) Appl. No.: 19/655,405

(22) Filed: Apr. 22, 2026

(30) Foreign Application Priority Data
Apr. 24, 2025 (JP) 2025-072254
Jan. 26, 2026 (JP) 2026-010864

(51) Int. Cl. H01F 1/153; C22C 38/00; C22C 38/02; C22C 38/10; H01F 3/04

(52) U.S. Cl. CPC H01F 1/15308; C22C 38/002; C22C 38/02; C22C 38/105; H01F 1/15333; H01F 1/15391; H01F 3/04

(57) ABSTRACT

A soft magnetic metal ribbon has a main component having a composition within a specified range. The soft magnetic metal ribbon includes an amorphous portion and a crystalline portion. An angle of one peak selected from X-ray diffraction peaks derived from crystals on a first surface of the soft magnetic metal ribbon is defined as 2θ₁, the Miller indices of the peak are defined as (h1, k1, l1), and 60.00°≤2θ₁≤66.00° is satisfied. An angle of one peak selected from X-ray diffraction peaks derived from crystals on a second surface located opposite to the first surface of the soft magnetic metal ribbon is defined as 2θ₂, the Miller indices of the peak are defined as (h2, k2, l2), and 60.00°≤2θ₂≤66.00° is satisfied. Δθ₁₂ is defined as 2θ₁−2θ₂, and 0.00°<|Δθ₁₂|≤4.90° and (h1, k1, l1)=(h2, k2, l2) are satisfied.

### TECHNICAL FIELD

The present disclosure relates to a soft magnetic metal ribbon, a magnetic core, and a magnetic device.

### BACKGROUND

In recent years, to improve the efficiency and reduce the size and weight of magnetic cores, magnetic materials for magnetic cores having low coercivity and high magnetic permeability have been required.

Patent Document 1 discloses an invention relating to an Fe-based amorphous alloy ribbon. The ribbon includes rows of laser-irradiation marks on at least one surface thereof, whereby iron loss is reduced and an increase in excitation power is suppressed.

Patent Document 2 discloses an invention relating to a method for manufacturing a nanocrystalline soft magnetic alloy. Patent Document 2 describes a method for nanocrystallizing an amorphous alloy ribbon by heat treatment. The method includes winding an amorphous alloy ribbon around a mandrel, performing a primary heat treatment by holding the ribbon at a temperature lower than a crystallization start temperature to relieve stress in the ribbon, removing the mandrel, and then performing a secondary heat treatment by holding the ribbon at a temperature equal to or higher than the crystallization start temperature. This method prevents a reduction in magnetic properties caused by stress generated during heat treatment.

### PATENT DOCUMENT

Patent Document 1: JP Patent No. 6687168
Patent Document 2: JP Patent Application Laid Open No. HO1-247557

### SUMMARY

To achieve the above-described object, a soft magnetic metal ribbon according to a first aspect of the present disclosure includes
a main component represented by a composition formula (Fe₁₋ₚX1ₚ)_{1-(a+b+c+d+e+f)}MₐB_{b}P_{c}Si_{d}CₑX2_{f}, in atomic ratio, where
X1 includes at least one selected from the group consisting of Co and Ni,
X2 includes at least one selected from the group consisting of Al, Ag, Zn, Sn, As, Sb, Cu, Cr, Bi, S, O, N, and a rare earth element,
M includes at least one selected from the group consisting of Nb, Hf, Zr, Ta, Ti, Mo, W, Mn, and V, and
0≤a≤0.100,
0.020≤b≤0.200,
0≤c≤0.100,
0≤d<0.160,
0≤e≤0.030,
0≤f≤0.030, and
0≤p≤0.500 are satisfied, wherein
the soft magnetic metal ribbon includes an amorphous portion and a crystalline portion;
an angle of one peak selected from X-ray diffraction peaks derived from crystals on a first surface of the soft magnetic metal ribbon is defined as 2θ₁, the Miller indices of the peak are defined as (h1, k1, l1), and 60.00°≤2θ₁≤66.00°;
an angle of one peak selected from X-ray diffraction peaks derived from crystals on a second surface of the soft magnetic metal ribbon located opposite to the first surface is defined as 2θ₂, the Miller indices of the peak are defined as (h2, k2, l2), and 60.00°≤2θ₂≤66.00°; and
Δθ₁₂ is defined as 2θ₁−2θ₂, and 0.00<|Δθ₁₂|≤4.90° and (h1, k1, l1)=(h2, k2, l2) are satisfied.

A magnetic core according to a second aspect of the present disclosure includes
a wound portion including a soft magnetic metal ribbon,
the soft magnetic metal ribbon including a main component represented by a composition formula (Fe₁₋ₚX1ₚ)_{1-(a+b+c+d+e+f)}MₐB_{b}P_{c}Si_{d}CₑX2_{f}, in atomic ratio, where
X1 includes at least one selected from the group consisting of Co and Ni,
X2 includes at least one selected from the group consisting of Al, Ag, Zn, Sn, As, Sb, Cu, Cr, Bi, S, O, N, and a rare earth element,
M includes at least one selected from the group consisting of Nb, Hf, Zr, Ta, Ti, Mo, W, Mn, and V, and
0≤a≤0.100,
0.020≤b≤0.200,
0≤c≤0.100,
0≤d<0.160,
0≤e≤0.030,
0≤f≤0.030, and
0≤p≤0.500 are satisfied, wherein
the wound portion includes an amorphous portion and a crystalline portion;
an angle of one peak selected from X-ray diffraction peaks derived from crystals on an outer surface of the soft magnetic metal ribbon located at an outermost surface of the wound portion is defined as 2θ₃, the Miller indices of the peak are defined as (h3, k3, l3), and 60.00°≤2θ₃≤66.00°;
an angle of one peak selected from X-ray diffraction peaks derived from crystals on an inner surface of the soft magnetic metal ribbon located at an innermost surface of the wound portion is defined as 2θ₄, the Miller indices of the peak are defined as (h4, k4, l4), and 60.00°≤2θ₄≤66.00°; and
Δθ₃₄ is defined as 2θ₃−2θ₄, and 0.00<|Δθ₃₄|≤4.90° and (h3, k3, l3)=(h4, k4, l4) are satisfied.

### BRIEF DESCRIPTION OF THE DRAWINGS

FIG. 1 is a schematic diagram of a magnetic core according to an embodiment of the present disclosure.

FIG. 2 is a schematic diagram of a magnetic core according to an embodiment of the present disclosure.

FIG. 3 is a schematic diagram of a magnetic core according to an embodiment of the present disclosure.

FIG. 4 is a schematic diagram of a single-roller melt-spinning method.

### DETAILED DESCRIPTION

An object of the present disclosure is to provide a soft magnetic metal ribbon having low coercivity and high permeability, a magnetic core, and the like.

The soft magnetic metal ribbon according to the first aspect of the present disclosure may satisfy 0≤d≤0.150.

The soft magnetic metal ribbon according to the first aspect of the present disclosure may include Fe-based nanocrystals having an average crystal grain size of 50.0 nm or less.

A magnetic core according to the first aspect of the present disclosure includes a wound portion including the soft magnetic metal ribbon.

Another magnetic core according to the first aspect of the present disclosure includes a laminated portion including the soft magnetic metal ribbon.

The magnetic core according to the second aspect of the present disclosure may satisfy 0≤d≤0.150.

In the magnetic core according to the second aspect of the present disclosure, the soft magnetic metal ribbon may include an amorphous portion and a crystalline portion;
an angle of one peak selected from X-ray diffraction peaks derived from crystals on a first surface of the soft magnetic metal ribbon is defined as 2θ₁, the Miller indices of the peak are defined as (h1, k1, l1), and 60.00°≤2θ₁≤66.00° may be satisfied;
an angle of one peak selected from X-ray diffraction peaks derived from crystals on a second surface of the soft magnetic metal ribbon located opposite to the first surface is defined as 2θ₂, the Miller indices of the peak are defined as (h2, k2, l2), and 60.00°≤2θ₂≤66.000 may be satisfied; and
Δθ₁₂ is defined as 2θ₁−2θ₂, and 0.00<|Δθ₁₂|≤4.90° and (h1, k1, l1)=(h2, k2, l2) may be satisfied.

In the magnetic core according to the second aspect of the present disclosure, the wound portion may have a shape including two or more arc segments having centers different from each other.

In the magnetic core according to the second aspect of the present disclosure, the radii of the two or more arc segments may be smaller than an equivalent circular diameter of a hollow portion of the wound portion.

A magnetic device according to the first aspect of the present disclosure includes the soft magnetic metal ribbon.

The magnetic device according to the first or second aspect of the present disclosure includes the magnetic core.

### First Embodiment

Hereinafter, a first embodiment of the present disclosure will be described with reference to the drawings. The present disclosure is not limited to the first and second embodiments described below, and may be implemented with appropriate modifications within the scope of the present disclosure. In addition, descriptions of portions that are duplicated may be omitted as appropriate, but such omission does not limit the scope of the present disclosure.

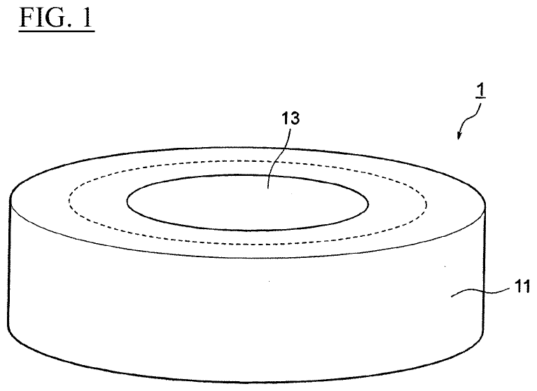

The shape of the magnetic core of the present embodiment is not particularly limited. For example, the magnetic core may be a toroidal magnetic core 1 as shown in FIG. 1. Hereinafter, a curved surface farthest from the center axis of the toroidal shape as shown in FIG. 1 is defined as the outermost surface 11, and a curved surface closest to the center axis of the toroidal shape is defined as the innermost surface 13.

The outer diameter, the inner diameter, and the height of the magnetic core 1 are not particularly limited. For example, the outer diameter may be 0.5 mm or more and 250 mm or less. The inner diameter may be 0.2 mm or more and 200 mm or less. The height may be 1.0 mm or more and 250 mm or less.

The type of the magnetic core 1 of the present embodiment is not particularly limited. Examples include a wound core 1 obtained by winding a soft magnetic metal ribbon, and a laminated core 1 obtained by laminating soft magnetic metal ribbons.

The soft magnetic metal ribbon according to the present embodiment includes a main component represented by a composition formula (Fe₁₋ₚX1ₚ)_{1-(a+b+c+d+e+f)}MₐB_{b}P_{c}Si_{d}CₑX2_{f}, in atomic ratio, where
X1 includes at least one selected from the group consisting of Co and Ni,
X2 includes at least one selected from the group consisting of Al, Ag, Zn, Sn, As, Sb, Cu, Cr, Bi, S, O, N, and a rare earth element,
M includes at least one selected from the group consisting of Nb, Hf, Zr, Ta, Ti, Mo, W, Mn, and V, and
0≤a≤0.100,
0.020≤b≤0.200,
0≤c≤0.100,
0≤d<0.160,
0≤e≤0.030,
0≤f≤0.030, and
0≤p≤0.500 are satisfied.

There are no particular limitations on the method for determining the composition of the soft magnetic metal ribbon, namely, the types of M, X1, and X2, and the values of a, b, c, d, e, f, and p. For example, the composition of the soft magnetic metal may be determined by scanning transmission electron microscopy (STEM), transmission electron microscopy (TEM), energy-dispersive X-ray spectroscopy (EDS), electron energy loss spectroscopy (EELS), fast Fourier transform (FFT) analysis of TEM images, powder X-ray diffraction (XRD), X-ray fluorescence spectroscopy (XRF), inductively coupled plasma atomic emission spectroscopy (ICP-AES), infrared absorption spectroscopy, or thermal conductivity analysis.

The details of each component of the soft magnetic metal ribbon of the present embodiment will be described below.

M includes at least one selected from the group consisting of Nb, Hf, Zr, Ta, Ti, Mo, W, Mn, and V.

The M content (a) satisfies 0≤a≤0.100. That is, M may be absent. In one example, the M content (a) may satisfy 0.020≤a≤0.080. A low M content (a) tends to increase the crystal grain size, increase coercivity, and decrease permeability μ′, each of which will be described later. A high M content (a) tends to decrease permeability μ′. The permeability μ′ refers to the real part of a complex permeability. Hereinafter, the permeability μ′ may simply be referred to as permeability.

The B content (b) satisfies 0.020≤b≤0.200. In one example, the B content (b) may satisfy 0.025≤b≤0.200, 0.060≤b≤0.180, or 0.080≤b≤0.180. A low B content (b) tends to increase the crystal grain size, increase coercivity, and decrease permeability, each of which will be described later. A high B content (b) tends to decrease permeability.

The P content (c) satisfies 0≤c≤0.100. That is, P may be absent. In one example, the P content (c) may satisfy 0.001≤c≤0.100 or 0.003≤c≤0.100. Setting the P content within the above-described range tends to decrease coercivity and increase permeability. When the P content (c) is too large, coercivity tends to increase, and permeability tends to decrease.

The Si content (d) satisfies 0≤d<0.160. That is, Si may be absent. In one example, the Si content (d) may satisfy 0≤d≤0.150 or 0≤d≤0.100. When the Si content (d) is too large, coercivity tends to increase, and permeability tends to decrease.

The C content (e) satisfies 0≤e≤0.030. That is, C may be absent. In one example, the C content (e) may satisfy 0≤e≤0.025 or 0≤e≤0.020. When the C content (e) is too large, coercivity tends to increase, and permeability tends to decrease.

X2 includes at least one selected from the group consisting of Al, Ag, Zn, Sn, As, Sb, Cu, Cr, Bi, S, O, N, and a rare earth element. The X2 content (f) satisfies 0≤f≤0.030. That is, X2 may be absent.

X1 includes at least one selected from the group consisting of Co and Ni. The value of p may be zero. That is, X1 may be absent. The symbol “p” is also referred to as a substitution ratio when a part of Fe is replaced with X1. In one example, 0≤p≤0.500 may be satisfied.

The total content of Fe and X1 (at least one selected from the group consisting of Co and Ni), which is (1−(a+b+c+d+e+f)), is not particularly limited and may be 0.720≤(1−(a+b+c+d+e+f))≤0.920. Setting the value of (1−(a+b+c+d+e+f)) within the above-described range makes it difficult to form crystal phases composed of crystals with an average crystal grain size of greater than 50 nm. In the following description, Z=1−(a+b+c+d+e+f).

The soft magnetic metal ribbon of the present embodiment may contain elements other than the above-described elements, namely, Fe, X1, X2, M, B, P, Si, and C, as inevitable impurities. For example, 0.5 wt % or less of inevitable impurities may be contained with respect to 100 wt % of the soft magnetic metal ribbon.

The soft magnetic metal ribbon of the present embodiment includes an amorphous portion and a crystalline portion. When the soft magnetic metal ribbon includes an amorphous portion and a crystalline portion, the amorphization ratio X described below is more than 0% and less than 100%.

The amorphization ratio X can be determined by X-ray crystal structure analysis using XRD, or by crystal orientation analysis using EBSD or electron diffraction. A method for determining the amorphization ratio X by X-ray crystal structure analysis using XRD will be described below.

The amorphization ratio X of a soft magnetic metal powder is represented by Equation (1) below.

X=100−(Ic/(Ic+Ia)×100) (1)
Ic: integrated intensity of crystalline scattering
Ia: integrated intensity of amorphous scattering

The amorphization ratio X is calculated as follows. X-ray crystal structure analysis using XRD is performed on the soft magnetic metal ribbon. In the analysis, phases are identified, and peaks (Ic: integrated intensity of crystalline scattering, Ia: integrated intensity of amorphous scattering) of crystallized Fe or crystallized compounds are determined. From the intensities of these peaks, a crystallization ratio is determined, and the amorphization ratio X is calculated using Equation (1) above. The calculation method will be more specifically described below.

X-ray crystal structure analysis using XRD is performed on the soft magnetic metal ribbon. The obtained pattern is subjected to profile fitting using a Lorentzian function represented by Equation (2) below. Thus, a crystal component pattern ac showing the integrated intensity of crystalline scattering, an amorphous component pattern aa showing the integrated intensity of amorphous scattering, and a pattern αc+a showing a combination thereof are obtained. The amorphization ratio X is calculated from the integrated intensity of crystalline scattering and that of amorphous scattering in the obtained pattern using Equation (1) above. The measurement range for determining the amorphization ratio X is set to a diffraction angle range of 2θ=30° to 60°, in which an amorphous halo is observed. In this range, the difference between the integrated intensity measured using XRD and the integrated intensity calculated using the Lorentzian function is set to 1% or less.

$$f ( x ) = \frac{h}{1 + \frac{{( x - u )}^{2}}{{w}^{2}}} + b \qquad ( 2 )$$

h: peak height
u: peak position
w: full width at half maximum
b: background intensity

The soft magnetic metal ribbon may include Fe-based nanocrystals having an average crystal grain size of 50 nm or less. The Fe-based nanocrystals refer to nanocrystals that include Fe as a main component. The Fe-based nanocrystals may be α-Fe nanocrystals. The α-Fe nanocrystals may include Co and/or Ni in solid solution. The α-Fe nanocrystals may include other constituent elements such as Si in solid solution. The Fe-based nanocrystals have a body-centered cubic (bcc) crystal structure.

One of the main surfaces of the soft magnetic metal ribbon is defined as a first surface. The other main surface, which is opposite to the first surface, is defined as a second surface.

The angle of the X-ray diffraction peak derived from Fe-containing crystals on the first and second surfaces of the soft magnetic metal ribbon is determined as follows. A pattern is obtained under a measurement condition in which the measurement range is 2θ=30° to 70°, and the obtained pattern is subjected to profile fitting using the Lorentzian function represented by Equation (2) above.

An angle of one peak selected from X-ray diffraction peaks derived from crystals on the first surface of the soft magnetic metal ribbon is defined as 2θ₁, the Miller indices of the peak are defined as (h1, k1, l1), and 60.00°≤2θ₁≤66.00° is satisfied. An angle of one peak selected from X-ray diffraction peaks derived from crystals on the second surface of the soft magnetic metal ribbon located opposite to the first surface is defined as 2θ₂, the Miller indices of the peak are defined as (h2, k2, l2), and 60.000≤2θ₂≤66.00° is satisfied. Moreover, Δθ₁₂ is defined as 2θ₁−2θ₂, and 0.00°<|Δθ₁₂|≤4.90° and (h1, k1, l1)=(h2, k2, l2) are satisfied.

In existing soft magnetic metal ribbons, the first and second surfaces have the same composition, and the crystals present on the first surface are the same as those present on the second surface. In addition, X-ray diffraction peaks measured on the first surface have the same peak positions as those measured on the second surface. In other words, when peaks having the same Miller indices are selected from the X-ray diffraction peaks of the first and second surfaces and their angles are defined as 2θ₁ and 2θ₂, respectively, 2θ₁=2θ₂ is satisfied. According to an existing technique, the soft magnetic metal ribbon may have a uniform structure throughout the ribbon, and therefore 2θ₁=2θ₂ may be satisfied for all X-ray diffraction peaks.

In the soft magnetic metal ribbon of the present embodiment, the surface roughness of the first surface is different from that of the second surface. As a result, the positions of atoms constituting a unit lattice differ between crystals present on the first surface and crystals present on the second surface. Thus, Δθ₁₂ is defined as 2θ₁−2θ₂, and there is an X-ray diffraction peak that satisfies 0.00°<|Δθ₁₂|≤4.90°.

The soft magnetic metal ribbon satisfying 0.00°<|Δθ₁₂|≤4.90° undergoes stress relaxation more easily than an existing soft magnetic metal ribbon satisfying Δθ₁₂=0. This tends to improve magnetic properties. In particular, coercivity decreases, and permeability increases.

In one example, 0.00°<|Δθ₁₂|≤1.000 may be satisfied, or alternatively, 0.00° <|Δθ₁₂|≤0.50° may be satisfied.

Specifically, when XRD measurement is performed on a soft magnetic metal ribbon containing Fe-based nanocrystals, large X-ray diffraction peaks derived from the nanocrystals tend to appear around 45° and 65°. For example, when indexed as bcc-Fe, the X-ray diffraction peak appearing around 45° has Miller indices (110). The X-ray diffraction peak appearing around 65° has Miller indices (200).

When XRD measurement is performed in a range of 2θ=30° to 90°, a relatively large X-ray diffraction peak derived from Fe-based nanocrystals also tends to appear around 2θ=82°. For example, when indexed as bcc-Fe, the X-ray diffraction peak appearing around 82° has Miller indices (211).

The heights of the X-ray diffraction peaks having peak angles of 2θ₁ and 2θ₂ are not particularly limited; however, when XRD measurement is performed in a range of 2θ=30° to 90°, the X-ray diffraction peaks may have peak intensities of 1/20 or more of the peak intensity of the highest X-ray diffraction peak.

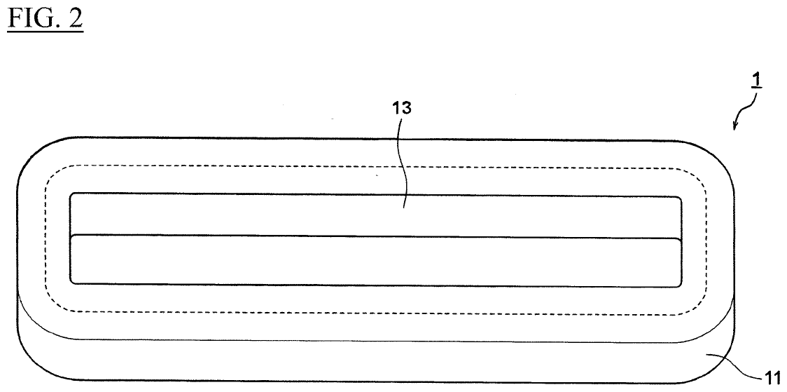

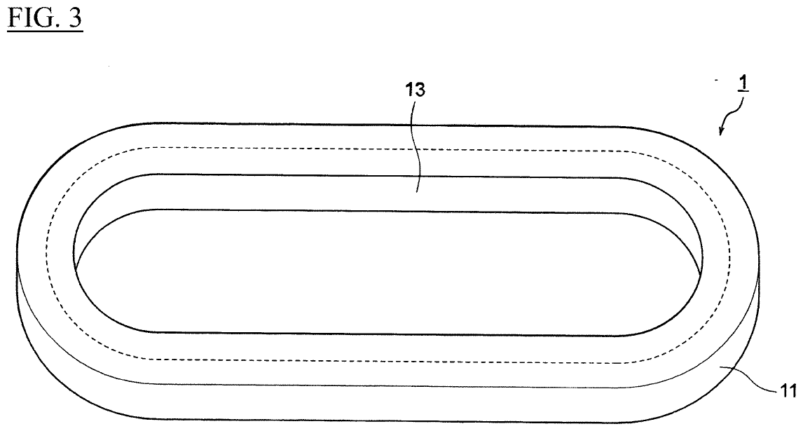

The magnetic core 1 of the present embodiment is obtained by winding the soft magnetic metal ribbon of the present embodiment. The magnetic core 1 of the present embodiment, which is obtained by winding, includes at least a wound portion in which the soft magnetic metal ribbon is wound. Examples of the shape of the magnetic core 1 include a toroidal shape as shown in FIG. 1, a rounded rectangular shape as shown in FIG. 2, and an elliptical shape as shown in FIG. 3. The shapes shown in FIGS. 1 to 3 are examples of the shape of the magnetic core 1 of the present embodiment. The shape of the magnetic core 1 may be freely selected depending on the intended purpose and application conditions.

The magnetic core 1 may have a hollow portion at the center where the soft magnetic metal ribbon is absent. A region that is surrounded by the soft magnetic metal ribbon is referred to as a hollow portion. The hollow portion may be an empty space. A constituent element other than the soft magnetic metal ribbon may be disposed in the hollow portion. For example, a bus bar, a winding wire, a fixing case, or resin may be disposed in the hollow portion.

The magnetic core 1 may include a plurality of substantially straight sides. The substantially straight sides may or may not oppose each other. The lengths of the substantially straight sides may be the same or different. Shapes having such sides can be used to represent shapes that partially include substantially straight sides, such as elliptical shapes or triangular shapes.

The outer dimensions of the magnetic core 1 having substantially straight sides may be defined as the side lengths of a circumscribed rectangle having the smallest area that encloses the entire outer contour of the magnetic core 1. When a plurality of circumscribed rectangles having the smallest area exist, any one of them may be selected as appropriate.

The inner dimensions of the magnetic core 1 having substantially straight sides may be defined as the side lengths of a circumscribed rectangle having the smallest area that encloses the entire hollow portion (interior of the inner circumferential contour). When a plurality of such rectangles exist, any one of them may be selected as appropriate.

Two sides that are orthogonal to each other are selected from the four sides of a circumscribed rectangle having the smallest area that encloses the entire outer circumferential contour, and the lengths of the selected two sides are defined as Loa and Lob (Loa≤Lob), respectively. In this case, 1≤Lob/Loa≤10 may be satisfied. Lob/Loa is calculated by rounding off the first decimal place.

Two sides that are orthogonal to each other are selected from the four sides of a circumscribed rectangle having the smallest area that encloses the entire hollow portion, and the lengths of the selected two sides are defined as Lia and Lib (Lia≤Lib), respectively. In this case, 1≤Lib/Lia≤20 may be satisfied. Lib/Lia is calculated by rounding off the first decimal place.

In another embodiment, the magnetic core 1 is obtained by laminating the soft magnetic metal ribbon. The magnetic core 1 of the present embodiment includes at least a laminated portion in which the soft magnetic metal ribbons are laminated.

Hereinafter, a method for manufacturing the soft magnetic metal ribbon of the present embodiment will be described.

The method for manufacturing the soft magnetic metal ribbon is not particularly limited. For example, the soft magnetic metal ribbon is manufactured by a single-roller melt-spinning method. The ribbon may be a continuous ribbon.

In the single-roller melt-spinning method, pure metals, alloys, and/or compounds of the respective metal elements contained in the soft magnetic metal ribbon finally obtained are first prepared as raw materials. The raw materials are then weighed so that the composition becomes identical to that of the soft magnetic metal ribbon finally obtained. The weighed raw materials are melted and mixed to prepare a base alloy. The method for melting the raw materials is not particularly limited; for example, the raw materials are melted by high-frequency heating after a chamber is evacuated. Normally, the base alloy and the soft magnetic metal ribbon finally obtained have the same composition.

Next, the prepared base alloy is heated and melted to obtain molten metal. The temperature of the molten metal is not particularly limited and may be, for example, 1200 °C to 1600 °C.

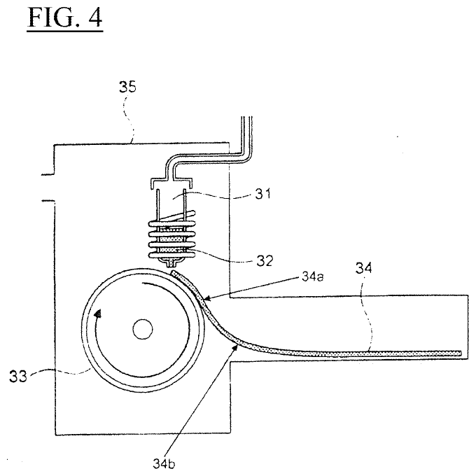

FIG. 4 shows a schematic diagram of an apparatus used in the single-roller melt-spinning method of the present embodiment. In the single-roller melt-spinning method of the present embodiment, in a chamber 35, molten metal 32 is sprayed from a nozzle 31 onto a roll 33 that is rotating in the direction indicated by an arrow, thereby producing a soft magnetic metal ribbon 34 in the rotational direction of the roll 33. The material of the roll 33 is not particularly limited. For example, a roll made of Cu may be used. The temperature of the roll 33 is also not particularly limited. For example, the temperature may be 20 °C to 80 °C.

Among the main surfaces of the soft magnetic metal ribbon 34, a surface that is not in contact with the roll 33 is referred to as a free surface 34a, and a surface that is in contact with the roll 33 is referred to as a roll surface 34b.

The thickness of the soft magnetic metal ribbon 34 can be controlled mainly by adjusting the rotational speed of the roll 33, the gap between the nozzle 31 and the roll 33, and the temperature of the molten metal. The thickness of the soft magnetic metal ribbon 34 is not particularly limited. For example, the thickness may be 5 μm to 200 μm.

The width of the soft magnetic metal ribbon 34 can be controlled mainly by adjusting the aperture of the nozzle 31 and the temperature of the molten metal. The width of the soft magnetic metal ribbon 34 is not particularly limited. For example, the width may be 5 mm to 200 mm.

The vapor pressure in the chamber 35 is not particularly limited. For example, the vapor pressure in the chamber 35 may be set to 1 hPa or less using Ar gas whose dew point has been adjusted. The chamber 35 may be omitted. That is, the vapor pressure in the atmosphere during performance of the single-roller melt-spinning method may be equivalent to atmospheric vapor pressure.

The soft magnetic metal ribbon 34 obtained immediately after the molten metal is cooled in the single-roller melt-spinning method may have a nanoheterostructure in which initial fine crystals are present in an amorphous phase. When the soft magnetic metal ribbon 34 is subjected to the heat treatment described below, Fe-based nanocrystals are easily precipitated in the soft magnetic metal ribbon 34. The average crystal grain size of the initial fine crystals is not particularly limited. For example, the average crystal grain size may be 0.5 nm to 3 nm.

The method for determining the presence and the average crystal grain size of the initial fine crystals is not particularly limited. For example, a sample that is thinned by ion milling may be observed using a transmission electron microscope. The presence and the average crystal grain size of the initial fine crystals may then be determined by obtaining and analyzing a selected-area electron diffraction image, a nanobeam diffraction image, a bright-field image, or a high-resolution image of the sample. When a selected-area electron diffraction image or a nanobeam diffraction image is used, a ring-shaped diffraction pattern is formed for an amorphous structure, and diffraction spots attributable to a crystal structure are formed for a structure other than the amorphous structure. When a bright-field image or a high-resolution image is used, the presence and the average crystal grain size of the initial fine crystals can be determined by visual observation at a magnification of 1.00×10⁵ to 3.00×10⁵.

The temperature and the rotational speed of the roll 33, as well as the atmosphere in the chamber 35, are not particularly limited. The temperature of the roll 33 may be set to 4 °C to 50 °C for amorphization. A higher rotational speed of the roll 33 tends to result in a smaller average crystal grain size of the initial fine crystals. The atmosphere in the chamber 35 may be air in view of cost.

Hereinafter, a method will be described for manufacturing a soft magnetic metal ribbon having an Fe-based nanocrystal structure by heat-treating a soft magnetic metal ribbon having an amorphous structure.

The heat treatment conditions for manufacturing the soft magnetic metal ribbon of the present embodiment are not particularly limited. Appropriate heat treatment conditions vary depending on the composition of the soft magnetic metal ribbon. Typically, the heat treatment temperature is approximately 450 °C to 650 °C, and the heat treatment time is approximately 0.5 hours to 10 hours. However, depending on the composition, the appropriate heat treatment temperature and the appropriate heat treatment time may fall outside the above-described ranges. The atmosphere during the heat treatment is not particularly limited. The heat treatment may be performed in an active atmosphere, such as air, or in an inert atmosphere, such as an Ar atmosphere.

There is no particular limitation on the method for calculating the average crystal grain size of the Fe-based nanocrystals formed in the soft magnetic metal ribbon by the heat treatment. For example, diameters may be measured on cross sections of Fe-based nanocrystals, and they may be averaged. First, a bright-field image of a cross section of the soft magnetic metal ribbon that is thinned by ion milling is obtained. In one example, a bright-field image may be obtained by observing a cross section of a thinned sample using a transmission electron microscope at a magnification of 1×10⁵ to 1×10⁶. The obtained bright-field image shows a large number of crystal grain images corresponding to Fe-based nanocrystals. Diameters are measured on the crystal grain images and are averaged, whereby an average crystal grain size of the Fe-based nanocrystals is determined.

The number of the crystal grain images for which diameters are measured is at least 100.

An equivalent circular diameter of the crystal grain image may be used as the diameter thereof. Specifically, the area of the crystal grain image is determined from the number of pixels constituting the crystal grain image, and the diameter of the crystal grain image is obtained by calculating an equivalent circular diameter from the area. For a circular crystal grain image, the diameter may be defined as the length of a line segment passing through the center and connecting two points on the circumference that are opposite each other.

The method for determining the crystal structure to be a body-centered cubic (bcc) structure is also not particularly limited. For example, the crystal structure may be determined by X-ray diffraction measurement.

To manufacture the soft magnetic metal ribbon 34 of the present embodiment, the free surface 34a and/or the roll surface 34b are polished prior to the heat treatment. Polishing may be performed on only one of the free surface 34a and the roll surface 34b. The polishing method is not particularly limited. For example, a polishing roll having abrasive paper wound around a roll may be used, and a grindstone roll having an electroplated grinding wheel on which diamond powder, CBN powder, or the like is deposited may also be used. Hereinafter, a case of using a grindstone roll will be described. The grit number of the grindstone is not particularly limited. For example, the grit number may be 1600 to 12000.

The surface polished as described above shows a shift of the peak angle toward a lower angle in the diffraction pattern. A grindstone having a smaller grit number results in a larger shift of the peak angle in the diffraction pattern. In view of this, at least one of the surfaces of the soft magnetic metal ribbon is polished using a grindstone having an appropriate grit number, whereby IΔθ₂| can be made greater than 0.00°.

Shrinkage stress is generated on the polished surface of the soft magnetic metal ribbon 34, and simultaneously, tensile stress is generated on the surface opposite thereto. This phenomenon facilitates stress relaxation in heat treatment performed after polishing. As a result, magnetic properties of the soft magnetic metal ribbon 34 tend to be improved.

Moreover, polishing reduces surface irregularities of the soft magnetic metal ribbon 34. As a result, the space factor of the magnetic core formed using the soft magnetic metal ribbon 34 can be increased, thereby facilitating improvement in magnetic properties.

However, when |Δθ₁₂| is too great, the difference between the stresses generated on both surfaces of the soft magnetic metal ribbon 34 may become excessively large. This may cause the magnetic properties of the soft magnetic metal ribbon 34 to deteriorate, and may also deteriorate the magnetic properties of the magnetic core formed using the soft magnetic metal ribbon 34.

A method for manufacturing the toroidal magnetic core (wound core) 1 shown in FIG. 1 will be described hereinafter. In the following description, the free surface 34a may be referred to as a first surface, and the roll surface 34b may be referred to as a second surface.

The magnetic core 1 includes a wound portion in which the soft magnetic metal ribbon is wound. In the present embodiment, the entire magnetic core 1 constitutes the wound portion. However, the wound portion may be included in only a part of the magnetic core 1.

If necessary, an adhesive layer may be formed on the first surface and/or the second surface of the soft magnetic metal ribbon, and a corrosion-resistant oil may be applied thereto. Any known adhesive layer may be used. Examples of the adhesive layer include adhesive layers formed from one or more of acrylic resins, silicone resins, butadiene resins, and epoxy resins, etc. The adhesive layer may be formed from a hot-melt adhesive or other similar materials. A double-sided tape having a PET substrate may be used as the adhesive layer. Any known corrosion-resistant oil may be used. For example, a petroleum solvent may be used. The magnetic core 1 (wound portion) may include elements in addition to the soft magnetic metal ribbon and the adhesive layer, provided that the function of the magnetic core 1 is not impaired. For example, the wound portion may have a mandrel. A protective film may be provided on the outer circumferential surface and/or the inner circumferential surface of the wound portion. Any known protective film may be used. Examples include PET films, polyimide films, and aramid films. In addition, the wound portion may be housed in a protective case made of resin, ceramic, or other materials.

The number of windings of the soft magnetic metal ribbon is not particularly limited. For example, the number of windings may be 1 or more and 15000 or less.

The first surface (free surface) may be used as the outermost surface 11, and the second surface (roll surface) may be used as the innermost surface 13. Alternatively, the first surface (free surface) may be used as the innermost surface 13, and the second surface (roll surface) may be used as the outermost surface 11.

A method for manufacturing the toroidal magnetic core (laminated core) 1 shown in FIG. 1 will be described hereinafter.

The magnetic core 1 includes a laminated portion in which the soft magnetic metal ribbons are laminated. In the present embodiment, the entire magnetic core 1 constitutes the laminated portion. However, the laminated portion may be included in only a part of the magnetic core 1.

If necessary, an adhesive layer may be formed on the first surface and/or the second surface of the soft magnetic metal ribbon. The adhesive layer may be formed on a polished surface or may be formed on a non-polished surface. The type of the adhesive layer may be the same as that of the adhesive layer of the wound core 1. The magnetic core 1 (laminated portion) may include elements in addition to the soft magnetic metal ribbon and the adhesive layer, provided that the function of the magnetic core 1 is not impaired. A protective film may be provided on an upper surface and/or a lower surface of the laminated core 1 (laminated portion) shown in FIG. 1. Any known protective film may be used. Examples include PET films, polyimide films, and aramid films. In addition, the laminated portion may be housed in a protective case made of resin, ceramic, or other materials.

The number of laminated layers of the soft magnetic metal ribbons is not particularly limited. For example, the number of laminated layers may be 4 or more and 25000 or less.

The orientations of the soft magnetic metal ribbons used to form the laminated portion are not particularly limited. For example, the soft magnetic metal ribbons may be laminated such that the first surface (free surface) of one ribbon and the second surface (roll surface) of another ribbon are in contact with each other, or such that the surfaces face each other across an adhesive layer. The soft magnetic metal ribbons may be laminated in a lamination direction so that the first and second surfaces are positioned as the two outermost surfaces.

Alternatively, the soft magnetic metal ribbons may be laminated in a lamination direction such that the first surfaces (free surfaces) are positioned as the two outermost surfaces, or such that the second surfaces (roll surfaces) are positioned as the two outermost surfaces. That is, the magnetic core 1 may include portions in which the first surfaces are in contact with each other and/or the second surfaces are in contact with each other, or portions in which the first surfaces face each other and/or the second surfaces face each other across an adhesive layer.

The magnetic device of the present embodiment includes the soft magnetic metal ribbon. The magnetic device of the present embodiment includes the magnetic core. The applications of the magnetic device are not particularly limited. The magnetic device can be suitably used in applications particularly requiring low power consumption and high efficiency. For example, the magnetic device can be suitably used in transformers, reactors, choke coils, and noise suppression devices.

### Second Embodiment

Hereinafter, the magnetic core according to the second embodiment will be described with reference to FIG. 1. Unless otherwise specified, features not described herein are the same as or similar to those of the first embodiment.

The magnetic core according to the present embodiment includes a wound portion in which a soft magnetic metal ribbon is wound, the soft magnetic metal ribbon including a main component represented by a composition formula (Fe₁₋ₚX1ₚ)_{1-(a+b+c+d+e+f)}MₐB_{b}P_{c}Si_{d}CₑX2_{f}, in atomic ratio, where
X1 includes at least one selected from the group consisting of Co and Ni,
X2 includes at least one selected from the group consisting of Al, Ag, Zn, Sn, As, Sb, Cu, Cr, Bi, S, O, N, and a rare earth element,
M includes at least one selected from the group consisting of Nb, Hf, Zr, Ta, Ti, Mo, W, Mn, and V, and
0≤a≤0.100,
0.020≤b≤0.200,
0≤c≤0.100,
0≤d<0.160,
0≤e≤0.030,
0≤f≤0.030, and
0≤p≤0.500 are satisfied.

That is, the magnetic core (wound core) according to the second embodiment has the same composition as that of the soft magnetic metal ribbon according to the first embodiment. The wound portion includes an amorphous portion and a crystalline portion, as in the wound core obtained by winding the soft magnetic metal ribbon according to the first embodiment.

The magnetic core of the present embodiment may include a wound portion that is formed by winding the soft magnetic metal ribbon. The entire magnetic core 1 shown in FIGS. 1 to 3 constitutes the wound portion. An angle of one peak selected from X-ray diffraction peaks derived from crystals on an outer surface of the soft magnetic metal ribbon located at the outermost surface 11 of the wound portion (magnetic core 1) is defined as 2θ₃, the Miller indices of the peak are defined as (h3, k3, l3), and 60.00°≤2θ₃≤66.000 is satisfied. An angle of one peak selected from X-ray diffraction peaks derived from crystals on an inner surface of the soft magnetic metal ribbon located at the innermost surface 13 of the wound portion (magnetic core 1) is defined as 2θ₄, the Miller indices of the peak are defined as (h4, k4, l4), and 60.000≤2θ₄≤66.00° is satisfied. Δθ₃₄ is defined as 2θ₃−2θ₄, and 0.00°<|Δθ₃₄|≤4.90° and (h3, k3, l3)=(h4, k4, l4) are satisfied.

The X-ray diffraction peak for determining θ₃ may be measured at any location on the outermost surface 11 of the wound portion. If necessary, the X-ray diffraction peak may be measured using a sample that is obtained by sampling an appropriately selected portion including the outermost surface 11. The X-ray diffraction peak for determining θ₄ may be measured at any location on the innermost surface 13 of the wound portion. If necessary, the X-ray diffraction peak may be measured using a sample that is obtained by sampling an appropriately selected portion including the innermost surface 13.

The magnetic core satisfying 0.00°<|Δθ₃₄|≤4.90° undergoes stress relaxation more easily than a magnetic core in which Δθ₃₄=0.00°. This tends to improve magnetic properties. In particular, coercivity decreases, and permeability increases.

In one example, 0.00°<|Δθ₃₄|≤1.00° may be satisfied, or alternatively, 0.00° <|Δθ₃₄|≤0.50° may be satisfied.

The magnetic core 1 of the present embodiment may have a wound portion that is formed by winding the soft magnetic metal ribbon according to the first embodiment. That is, the soft magnetic metal ribbon used for manufacturing the magnetic core 1 of the present embodiment may have the same composition as the soft magnetic metal ribbon of the first embodiment. The soft magnetic metal ribbon used for manufacturing the magnetic core 1 of the present embodiment may include an amorphous portion and a crystalline portion, as in the soft magnetic metal ribbon of the first embodiment. The soft magnetic metal ribbon used for manufacturing the magnetic core 1 of the present embodiment may have the following features. An angle of one peak selected from X-ray diffraction peaks derived from crystals on the first surface is defined as 2θ₁, the Miller indices of the peak are defined as (h1, k1, l1), and 60.00°≤2θ₁≤66.00° may be satisfied. An angle of one peak selected from X-ray diffraction peaks derived from crystals on the second surface located opposite to the first surface is defined as 2θ₂, the Miller indices of the peak are defined as (h2, k2, l2), and 60.00°≤2θ₂≤66.00° may be satisfied. Δθ₁₂ is defined as 2θ₁−2θ₂, and 0.00°<|Δθ₁₂|≤4.90° and (h1, k1, l1)=(h2, k2, l2) may be satisfied.

The shape of the inner circumference of the wound portion in a cross section perpendicular to the winding axis may have two or more arc segments having centers different from each other. An arc segment refers to a segment of an arc of a circle used to determine a radius of curvature R, which represents the curvature of a local portion of a curved portion. If the shape of the local portion is an arc, a circle including the arc is defined as a circle of curvature, and the geometrical radius of the arc (radius of the circle of curvature) is defined as the radius of curvature R. If the shape of the local portion is not an arc, an arc having a shape closest to that of the local portion is fitted. In the fitting, for example, a circle having a portion overlapping the local portion with the greatest length may be used as an arc segment. The geometrical radius of the arc (radius of the circle) is defined as the radius of curvature R. In addition, a local portion having a length of less than 100 μm, and an arc segment having a radius of curvature of less than 50 μm, are not considered.

The radii of two or more of the arc segments in a cross section perpendicular to the winding axis may be smaller than an equivalent circular diameter of the hollow portion of the wound portion.

The shape of the outer circumference of the wound portion in a cross section perpendicular to the winding axis may have two or more arc segments with mutually different centers, and the radii of the two or more arc segments may be smaller than the equivalent circular diameter of the hollow portion of the wound portion. Examples of such a shape include a rounded rectangular shape including four corner portions and four straight portions as shown in FIG. 2, a rounded triangular shape including three corner portions and three straight portions, and an oval shape including two corner portions and straight portions as shown in FIG. 3.

There is no particular limitation on the circumferential length at the center of the wound core, that is, the length of a line located at a position equally distant from the outer circumferential surface and the inner circumferential surface of the wound core (dashed line in FIGS. 1 to 3). For example, the circumferential length at the center may be 1 mm or more and 1000 mm or less. The circumferential length at the center may be measured directly or may be calculated from a radius of curvature R of an arc segment and a length of a substantially straight portion.

The method for manufacturing the magnetic core 1 of the present embodiment is the same or similar to that of the wound core 1 of the first embodiment.

### EXAMPLES

### Experimental Example 1

### <Manufacturing of Soft Magnetic Metal Ribbon>

For sample Nos. 1-1 to 1-33, raw material metals were weighed so that the alloy composition was Fe_{0.820}Nb_{0.60}B_{0.090}P_{0.030} in atomic ratio, and the weighed raw material metals were melted by high-frequency heating to prepare a base alloy. For sample Nos. 2-1 to 2-33, raw material metals were weighed so that the alloy composition was Fe_{0.735}Nb_{0.030}B_{0.090}Si_{0.135}Cu_{0.010} in atomic ratio, and the weighed raw material metals were melted by high-frequency heating to prepare a base alloy.

Then, the prepared base alloy was melted by heating to obtain molten metal. The molten metal was formed into a ribbon by a single-roller melt-spinning method using the apparatus shown in FIG. 4. The atmosphere in the chamber was air. The thickness of the ribbon was approximately 20 μm. The width of the ribbon was 10 mm and was equal to the height of a wound portion, which will be described below.

Next, in each example, one surface of the ribbon was polished using a grindstone roll. The polishing amount was adjusted by controlling the polishing conditions according to the grit number of the grindstone roll, thereby adjusting the thickness of the ribbon. Specifically, polishing was performed so that the thickness of the ribbon was 20 μm. The surface subjected to polishing and the grit number of the grindstone roll are shown in Tables 1A and 1B.

Thereafter, the ribbon was subjected to heat treatment. The heat treatment was performed at a heat treatment temperature of 575 °C with a holding time of 60 minutes.

### <Magnetic Properties of Soft Magnetic Metal Ribbon>

The coercivity of the soft magnetic metal ribbon was measured using an HC meter (K-HC1000, manufactured by Tohoku Steel Co., Ltd.). The permeability was measured at a frequency of 1 kHz using a BH analyzer (SY-8218, manufactured by Iwatsu Electric Co., Ltd.) and a small single-sheet magnetic measurement apparatus (SY-956, manufactured by Iwatsu Electric Co., Ltd.). Moreover, improvement rates of coercivity and permeability were calculated using reference data obtained from samples that were prepared under the same conditions except that polishing was not performed. Results are shown in Tables 1A and 1B. Samples were rated as “D” when at least one of the improvement rates of coercivity and permeability was less than 5%. Samples were rated as “C” when the improvement rates of coercivity and permeability were 5% or more and at least one of the improvement rates of coercivity and permeability was less than 10%. Samples were rated as “B” when the improvement rates of coercivity and permeability were 10% or more and at least one of the improvement rates of coercivity and permeability was less than 20%. Samples were rated as “A” when the improvement rates of coercivity and permeability were 20% or more. For the soft magnetic metal ribbons of the examples and comparative examples, the magnetic properties are superior in the order of grades A, B, C, and D, and grades A to C are regarded as favorable.

### <Microstructure of Soft Magnetic Metal Ribbon>

The microstructures on the free surface and the roll surface of each heat-treated ribbon were analyzed by X-ray diffraction measurement (XRD). As a result, all the ribbons contained Fe-based nanocrystalline portions and amorphous portions on both the free surface and the roll surface. Moreover, the average crystal grain size of the Fe-based nanocrystals on each surface was determined. The average crystal grain sizes of the Fe-based nanocrystals were the same or similar on both the free surface and the roll surface for the same ribbon. Results are shown in Tables 1A and 1B.

Furthermore, for each of the roll surface and the free surface of each heat-treated ribbon, a diffraction pattern was obtained in the range of 2θ=30° to 70° and analyzed. On both the roll surface and the free surface of every sample, a large peak derived from the Fe-based nanocrystals was observed around 2θ=45°, and another large peak was observed around 2θ=65°. The peak angles of the diffraction peaks observed around 65° in the diffraction patterns of the roll surface and the free surface were determined, and the angle difference between the peak angles was calculated. Results are shown in Tables 1A and 1B. The Miller indices of the large peak observed around 450 were the same in all the diffraction patterns. The Miller indices of the large peak observed around 65° were the same in all the diffraction patterns.

TABLE 1A

| | | | | Diffraction Peak Angle | | | | | | | | |
|---|---|---|---|---|---|---|---|---|---|---|---|---|
| | | | | (Around 65°) | | | | | | | | |
| | | Ribbon Surface | | (°) | | | Crystal | | | | | |
| | Example/ | Polishing | | Free | Roll | | Grain | | | Permeability | | |
| Sample | Comparative | Polished | Grit | Surface | Surface | Difference | Size | Coercivity | Coercivity | (×10³) | Permeability | |
| No. | Example | Surface | Number | 2θ₁ | 2θ₂ | \|Δθ₁₂\| | (nm) | (A/m) | Improvement | [1 kHz] | Improvement | Grade |
| 1-1 | Comparative | — | — | 64.94 | 64.94 | 0.00 | 11.3 | 7.3 | — | 18.2 | — | D |
| | Example | | | | | | | | | | | |
| 1-2 | Example | Free | 12000 | 64.90 | 64.91 | 0.01 | 11.5 | 5.8 | 21% | 22.0 | 21% | A |
| 1-3 | Example | Roll | 12000 | 64.91 | 64.89 | 0.02 | 11.5 | 5.7 | 22% | 21.9 | 20% | A |
| 1-4 | Example | Free | 10000 | 64.87 | 64.92 | 0.05 | 11.4 | 5.5 | 25% | 22.2 | 22% | A |
| 1-5 | Example | Roll | 10000 | 64.91 | 64.85 | 0.06 | 11.6 | 5.5 | 25% | 22.2 | 22% | A |
| 1-6 | Example | Free | 9000 | 64.78 | 64.89 | 0.11 | 11.5 | 5.3 | 27% | 22.5 | 24% | A |
| 1-7 | Example | Roll | 9000 | 64.91 | 64.79 | 0.12 | 11.5 | 5.4 | 26% | 22.6 | 24% | A |
| 1-8 | Example | Free | 8000 | 64.75 | 64.92 | 0.17 | 11.4 | 4.3 | 41% | 23.8 | 31% | A |
| 1-9 | Example | Roll | 8000 | 64.91 | 64.73 | 0.18 | 11.4 | 4.4 | 40% | 23.7 | 30% | A |
| 1-10 | Example | Free | 7500 | 64.69 | 64.92 | 0.23 | 11.6 | 4.6 | 37% | 23.1 | 27% | A |
| 1-11 | Example | Roll | 7500 | 64.92 | 64.68 | 0.24 | 11.4 | 4.7 | 36% | 23.2 | 27% | A |
| 1-12 | Example | Free | 7000 | 64.55 | 64.91 | 0.36 | 11.6 | 5.0 | 31% | 22.8 | 25% | A |
| 1-13 | Example | Roll | 7000 | 64.92 | 64.55 | 0.37 | 11.5 | 5.1 | 30% | 22.8 | 25% | A |
| 1-14 | Example | Free | 6000 | 64.53 | 64.93 | 0.40 | 11.5 | 5.2 | 29% | 22.6 | 24% | A |
| 1-15 | Example | Roll | 6000 | 64.92 | 64.51 | 0.41 | 11.3 | 5.2 | 29% | 22.7 | 25% | A |
| 1-16 | Example | Free | 5000 | 64.43 | 64.93 | 0.50 | 11.3 | 5.5 | 25% | 22.3 | 23% | A |
| 1-17 | Example | Roll | 5000 | 64.94 | 64.44 | 0.50 | 11.2 | 5.4 | 26% | 22.3 | 23% | A |
| 1-18 | Example | Free | 4000 | 64.21 | 64.89 | 0.68 | 11.2 | 6.0 | 18% | 21.4 | 18% | B |
| 1-19 | Example | Roll | 4000 | 64.91 | 64.25 | 0.66 | 11.4 | 6.1 | 16% | 21.7 | 19% | B |
| 1-20 | Example | Free | 3000 | 63.91 | 64.90 | 0.99 | 11.3 | 6.5 | 11% | 20.8 | 14% | B |
| 1-21 | Example | Roll | 3000 | 64.92 | 63.92 | 1.00 | 11.5 | 6.5 | 11% | 20.7 | 14% | B |
| 1-22 | Example | Free | 2400 | 63.91 | 64.92 | 1.01 | 11.4 | 6.7 | 8% | 19.9 | 9% | C |
| 1-23 | Example | Roll | 2400 | 64.93 | 63.91 | 1.02 | 11.5 | 6.7 | 8% | 19.8 | 9% | C |
| 1-24 | Example | Free | 2200 | 61.83 | 64.88 | 3.05 | 11.5 | 6.7 | 8% | 19.8 | 9% | C |
| 1-25 | Example | Roll | 2200 | 64.88 | 61.80 | 3.08 | 11.3 | 6.7 | 8% | 19.7 | 8% | C |
| 1-26 | Example | Free | 2000 | 61.01 | 65.01 | 4.00 | 11.5 | 6.8 | 7% | 19.7 | 8% | C |
| 1-27 | Example | Roll | 2000 | 65.02 | 61.01 | 4.01 | 11.4 | 6.7 | 8% | 19.7 | 8% | C |
| 1-28 | Example | Free | 1800 | 61.03 | 65.04 | 4.01 | 11.5 | 6.8 | 7% | 19.5 | 7% | C |
| 1-29 | Example | Roll | 1800 | 65.06 | 61.05 | 4.01 | 11.4 | 6.8 | 7% | 19.5 | 7% | C |
| 1-30 | Example | Free | 1600 | 60.05 | 64.95 | 4.90 | 11.6 | 6.8 | 7% | 19.4 | 7% | C |
| 1-31 | Example | Roll | 1600 | 64.95 | 60.05 | 4.90 | 11.6 | 6.9 | 5% | 19.3 | 6% | C |
| 1-32 | Comparative | Free | 1500 | 60.00 | 64.91 | 4.91 | 11.7 | 7.1 | 3% | 18.6 | 2% | D |
| | Example | | | | | | | | | | | |
| 1-33 | Comparative | Roll | 1500 | 64.93 | 60.02 | 4.91 | 11.6 | 7.2 | 2% | 18.6 | 2% | D |
| | Example | | | | | | | | | | | |

TABLE 1B

| | | | | Diffraction Peak Angle | | | | | | | | |
|---|---|---|---|---|---|---|---|---|---|---|---|---|
| | | | | (Around 65°) | | | | | | | | |
| | | Ribbon Surface | | (°) | | | Crystal | | | | | |
| | Example/ | Polishing | | Free | Roll | | Grain | | | Permeability | | |
| Sample | Comparative | Polished | Grit | Surface | Surface | Difference | Size | Coercivity | Coercivity | (×10³) | Permeability | |
| No. | Example | Surface | Number | 2θ₁ | 2θ₂ | \|Δθ₁₂\| | (nm) | (A/m) | Improvement | [1 kHz] | Improvement | Grade |
| 2-1 | Comparative | — | — | 65.89 | 65.89 | 0.00 | 16.4 | 3.2 | — | 72.3 | — | D |
| | Example | | | | | | | | | | | |
| 2-2 | Example | Free | 12000 | 65.87 | 65.88 | 0.01 | 16.6 | 2.5 | 22% | 87.8 | 21% | A |
| 2-3 | Example | Roll | 12000 | 65.87 | 65.85 | 0.02 | 16.5 | 2.4 | 25% | 87.8 | 21% | A |
| 2-4 | Example | Free | 10000 | 65.82 | 65.89 | 0.07 | 16.7 | 2.3 | 28% | 87.9 | 22% | A |
| 2-5 | Example | Roll | 10000 | 65.88 | 65.80 | 0.08 | 16.6 | 2.2 | 31% | 88.0 | 22% | A |
| 2-6 | Example | Free | 9000 | 65.71 | 65.88 | 0.17 | 16.5 | 1.7 | 47% | 89.2 | 23% | A |
| 2-7 | Example | Roll | 9000 | 65.87 | 65.69 | 0.18 | 16.4 | 1.7 | 47% | 89.3 | 24% | A |
| 2-8 | Example | Free | 8000 | 65.57 | 65.85 | 0.28 | 16.2 | 1.2 | 63% | 89.6 | 24% | A |
| 2-9 | Example | Roll | 8000 | 65.84 | 65.55 | 0.29 | 16.3 | 1.2 | 63% | 89.5 | 24% | A |
| 2-10 | Example | Free | 7500 | 65.49 | 65.87 | 0.38 | 16.4 | 1.7 | 47% | 88.9 | 23% | A |
| 2-11 | Example | Roll | 7500 | 65.88 | 65.48 | 0.40 | 16.5 | 1.8 | 44% | 89.0 | 23% | A |
| 2-12 | Example | Free | 7000 | 65.37 | 65.87 | 0.50 | 16.4 | 2.4 | 25% | 87.9 | 22% | A |
| 2-13 | Example | Roll | 7000 | 65.87 | 65.37 | 0.50 | 16.6 | 2.4 | 25% | 87.9 | 22% | A |
| 2-14 | Example | Free | 6000 | 65.25 | 65.88 | 0.63 | 16.6 | 2.6 | 19% | 86.2 | 19% | B |
| 2-15 | Example | Roll | 6000 | 65.89 | 65.24 | 0.65 | 16.5 | 2.6 | 19% | 86.2 | 19% | B |
| 2-16 | Example | Free | 5000 | 65.02 | 65.82 | 0.80 | 16.2 | 2.6 | 19% | 82.3 | 14% | B |
| 2-17 | Example | Roll | 5000 | 65.81 | 65.02 | 0.79 | 16.4 | 2.7 | 16% | 82.2 | 14% | B |
| 2-18 | Example | Free | 4000 | 64.88 | 65.87 | 0.99 | 16.4 | 2.7 | 16% | 80.7 | 12% | B |
| 2-19 | Example | Roll | 4000 | 65.89 | 64.89 | 1.00 | 16.3 | 2.8 | 13% | 80.6 | 11% | B |
| 2-20 | Example | Free | 3000 | 64.87 | 65.88 | 1.01 | 16.5 | 2.9 | 9% | 79.1 | 9% | C |
| 2-21 | Example | Roll | 3000 | 65.85 | 64.83 | 1.02 | 16.8 | 2.9 | 9% | 79.0 | 9% | C |
| 2-22 | Example | Free | 2400 | 63.86 | 65.89 | 2.03 | 16.6 | 2.9 | 9% | 78.7 | 9% | C |
| 2-23 | Example | Roll | 2400 | 65.89 | 63.87 | 2.02 | 16.7 | 2.9 | 9% | 78.6 | 9% | C |
| 2-24 | Example | Free | 2000 | 62.98 | 65.88 | 2.90 | 16.2 | 3.0 | 6% | 77.8 | 8% | C |
| 2-25 | Example | Roll | 2000 | 65.88 | 62.97 | 2.91 | 16.5 | 3.0 | 6% | 77.8 | 8% | C |
| 2-26 | Example | Free | 2200 | 61.88 | 65.88 | 4.00 | 16.6 | 2.9 | 9% | 77.4 | 7% | C |
| 2-27 | Example | Roll | 2200 | 65.87 | 61.87 | 4.00 | 16.5 | 3.0 | 6% | 77.4 | 7% | C |
| 2-28 | Example | Free | 1800 | 61.89 | 65.91 | 4.02 | 16.4 | 3.0 | 6% | 77.1 | 7% | C |
| 2-29 | Example | Roll | 1800 | 65.92 | 61.91 | 4.01 | 16.3 | 3.0 | 6% | 77.2 | 7% | C |
| 2-30 | Example | Free | 1600 | 61.10 | 66.00 | 4.90 | 16.3 | 3.0 | 6% | 76.2 | 5% | C |
| 2-31 | Example | Roll | 1600 | 65.99 | 61.09 | 4.90 | 16.4 | 3.0 | 6% | 76.1 | 5% | C |
| 2-32 | Comparative | Free | 1500 | 60.98 | 65.89 | 4.91 | 16.5 | 3.1 | 3% | 73.2 | 1% | D |
| | Example | | | | | | | | | | | |
| 2-33 | Comparative | Roll | 1500 | 65.88 | 60.97 | 4.91 | 16.4 | 3.2 | 0% | 73.1 | 1% | D |
| | Example | | | | | | | | | | | |

As shown in Tables 1A and 1B, examples in which one surface was polished using a grindstone roll having a grit number of 1600 or more exhibited superior magnetic properties compared with comparative examples prepared under the same conditions except that polishing was not performed. On the other hand, comparative examples in which one surface was polished using a grindstone roll having a grit number of 1500 exhibited deteriorated magnetic properties compared with comparative examples prepared under the same conditions except that polishing was not performed. This phenomenon is considered to be due to an excessively large angle difference between the roll surface and the free surface in the diffraction patterns caused by the excessively small grit number of the grindstone roll.

### Experimental Example 2

Experimental Example 2 was conducted for Sample Nos. 1-1 and 1-8 of Experimental Example 1 under the same conditions except that the composition was changed. Results are shown in Tables 2A to 8D. In Tables 2A to 9 below, data of diffraction peak angles other than |Δθ₁₂| around 65° were omitted.

TABLE 2A

| | | (Fe₁₋ₚ X1ₚ)_{Z} Mₐ B_{b} P_{c} Si_{d} Cₑ X2_{f} | | | | | | | | Crystal | | Coer- | Perme- | Perme- | |
|---|---|---|---|---|---|---|---|---|---|---|---|---|---|---|---|
| | Example/ | (p = 0, e = f = 0, M:Nb) | | | | | | | Around | Grain | Coer- | civity | ability | ability | |
| Sample | Comparative | Fe | M(Nb) | B | P | Si | C | X2 | 65° | Size | civity | Improve- | (×10³) | Improve- | |
| No. | Example | Z | a | b | c | d | e | f | \|Δθ₁₂\| | (nm) | (A/m) | ment | [1 kHz] | ment | Grade |
| 3-1 | Comparative | 0.720 | 0.060 | 0.090 | 0.030 | 0.100 | 0.000 | 0.000 | 0.00 | 12.0 | 11.6 | — | 9.8 | — | D |
| | Example | | | | | | | | | | | | | | |
| 3-2 | Example | 0.720 | 0.060 | 0.090 | 0.030 | 0.100 | 0.000 | 0.000 | 0.18 | 11.8 | 9.2 | 21% | 12.0 | 22% | A |
| 4-1 | Comparative | 0.770 | 0.060 | 0.090 | 0.030 | 0.050 | 0.000 | 0.000 | 0.00 | 11.8 | 10.9 | — | 11.9 | — | D |
| | Example | | | | | | | | | | | | | | |
| 4-2 | Example | 0.770 | 0.060 | 0.090 | 0.030 | 0.050 | 0.000 | 0.000 | 0.16 | 11.7 | 7.7 | 29% | 14.8 | 24% | A |
| 5-1 | Comparative | 0.790 | 0.060 | 0.090 | 0.030 | 0.030 | 0.000 | 0.000 | 0.00 | 11.5 | 8.9 | — | 14.6 | — | D |
| | Example | | | | | | | | | | | | | | |
| 5-2 | Example | 0.790 | 0.060 | 0.090 | 0.030 | 0.030 | 0.000 | 0.000 | 0.17 | 11.4 | 5.4 | 39% | 18.8 | 29% | A |
| 1-1 | Comparative | 0.820 | 0.060 | 0.090 | 0.030 | 0.000 | 0.000 | 0.000 | 0.00 | 11.3 | 7.3 | — | 18.2 | — | D |
| | Example | | | | | | | | | | | | | | |
| 1-8 | Example | 0.820 | 0.060 | 0.090 | 0.030 | 0.000 | 0.000 | 0.000 | 0.11 | 11.4 | 4.3 | 41% | 23.8 | 31% | A |
| 6-1 | Comparative | 0.840 | 0.040 | 0.090 | 0.030 | 0.000 | 0.000 | 0.000 | 0.00 | 13.7 | 13.8 | — | 15.9 | — | D |
| | Example | | | | | | | | | | | | | | |
| 6-2 | Example | 0.840 | 0.040 | 0.090 | 0.030 | 0.000 | 0.000 | 0.000 | 0.10 | 13.5 | 10.1 | 27% | 20.3 | 28% | A |
| 7-1 | Comparative | 0.860 | 0.040 | 0.070 | 0.030 | 0.000 | 0.000 | 0.000 | 0.00 | 16.1 | 15.4 | — | 13.8 | — | D |
| | Example | | | | | | | | | | | | | | |
| 7-2 | Example | 0.860 | 0.040 | 0.070 | 0.030 | 0.000 | 0.000 | 0.000 | 0.14 | 15.9 | 10.4 | 32% | 17.6 | 28% | A |
| 8-1 | Comparative | 0.910 | 0.040 | 0.050 | 0.000 | 0.000 | 0.000 | 0.000 | 0.00 | 17.8 | 19.8 | — | 11.3 | — | D |
| | Example | | | | | | | | | | | | | | |
| 8-2 | Example | 0.910 | 0.040 | 0.050 | 0.000 | 0.000 | 0.000 | 0.000 | 0.16 | 17.7 | 14.3 | 28% | 14.5 | 28% | |
| 9-1 | Comparative | 0.920 | 0.040 | 0.040 | 0.000 | 0.000 | 0.000 | 0.000 | 0.00 | 20.4 | 24.8 | — | 6.6 | — | D |
| | Example | | | | | | | | | | | | | | |
| 9-2 | Example | 0.920 | 0.040 | 0.040 | 0.000 | 0.000 | 0.000 | 0.000 | 0.08 | 20.2 | 18.1 | 27% | 8.3 | 26% | A |

TABLE 2B

| | | | (Fe₁₋ₚ X1ₚ)_{Z} Mₐ B_{b} P_{c} Si_{d} Cₑ X2_{f} | | | | | | |
|---|---|---|---|---|---|---|---|---|---|
| | Example/ | | (d = e = f = 0, M:Nb) | | | | | | |
| Sample | Comparative | | Fe + X1 | X1 | | M(Nb) | B | P | Si |
| No. | Example | | Z | Type | p | a | b | c | d |
| 1-1 | Comparative | | 0.820 | Co | 0.00 | 0.060 | 0.090 | 0.030 | 0.000 |
| | Example | | | | | | | | |
| 1-8 | Example | | 0.820 | Co | 0.00 | 0.060 | 0.090 | 0.030 | 0.000 |
| 10-1 | Comparative | | 0.820 | Co | 0.05 | 0.060 | 0.090 | 0.030 | 0.000 |
| | Example | | | | | | | | |
| 10-2 | Example | | 0.820 | Co | 0.05 | 0.060 | 0.090 | 0.030 | 0.000 |
| 11-1 | Comparative | | 0.820 | Co | 0.10 | 0.060 | 0.090 | 0.030 | 0.000 |
| | Example | | | | | | | | |
| 11-2 | Example | | 0.820 | Co | 0.10 | 0.060 | 0.090 | 0.030 | 0.000 |
| 12-1 | Comparative | | 0.820 | Co | 0.25 | 0.060 | 0.090 | 0.030 | 0.000 |
| | Example | | | | | | | | |
| 12-2 | Example | | 0.820 | Co | 0.25 | 0.060 | 0.090 | 0.030 | 0.000 |
| 13-1 | Comparative | | 0.820 | Co | 0.40 | 0.060 | 0.090 | 0.030 | 0.000 |
| | Example | | | | | | | | |
| 13-2 | Example | | 0.820 | Co | 0.40 | 0.060 | 0.090 | 0.030 | 0.000 |
| 14-1 | Comparative | | 0.820 | Co | 0.50 | 0.060 | 0.090 | 0.030 | 0.000 |
| | Example | | | | | | | | |
| 14-2 | Example | | 0.820 | Co | 0.50 | 0.060 | 0.090 | 0.030 | 0.000 |
| 15-1 | Comparative | | 0.820 | Co | 0.60 | 0.060 | 0.090 | 0.030 | 0.000 |
| | Example | | | | | | | | |
| 15-2 | Comparative | | 0.820 | Co | 0.60 | 0.060 | 0.090 | 0.030 | 0.000 |
| | Example | | | | | | | | |
| | (Fe₁₋ₚ X1ₚ)_{Z} Mₐ | | | | | | | | |
| | B_{b} P_{c} Si_{d} Cₑ X2_{f} | | | Crystal | | | | | |
| | (d = e = f = 0, M:Nb) | | Around | Grain | | | Permeability | | |
| Sample | C | X2 | 65° | Size | Coercivity | Coercivity | (×10³) | Permeability | |
| No. | e | f | \|Δθ₁₂\| | (nm) | (A/m) | Improvement | [1 kHz] | Improvement | Grade |
| 1-1 | 0.000 | 0.000 | 0.00 | 11.3 | 7.3 | — | 18.2 | — | D |
| 1-8 | 0.000 | 0.000 | 0.11 | 11.4 | 4.3 | 41% | 23.8 | 31% | A |
| 10-1 | 0.000 | 0.000 | 0.00 | 12.4 | 9.2 | — | 13.6 | — | D |
| 10-2 | 0.000 | 0.000 | 0.09 | 12.3 | 6.3 | 32% | 17.6 | 29% | A |
| 11-1 | 0.000 | 0.000 | 0.00 | 12.6 | 10.7 | — | 11.3 | — | D |
| 11-2 | 0.000 | 0.000 | 0.12 | 12.5 | 7.6 | 29% | 14.4 | 27% | A |
| 12-1 | 0.000 | 0.000 | 0.00 | 12.2 | 11.9 | — | 6.6 | — | D |
| 12-2 | 0.000 | 0.000 | 0.15 | 12.3 | 8.8 | 26% | 8.4 | 27% | A |
| 13-1 | 0.000 | 0.000 | 0.00 | 12.6 | 12.5 | — | 3.1 | — | D |
| 13-2 | 0.000 | 0.000 | 0.14 | 12.6 | 9.4 | 25% | 3.9 | 26% | A |
| 14-1 | 0.000 | 0.000 | 0.00 | 12.8 | 13.1 | — | 2.2 | — | D |
| 14-2 | 0.000 | 0.000 | 0.13 | 12.9 | 10.2 | 22% | 2.7 | 23% | A |
| 15-1 | 0.000 | 0.000 | 0.00 | 13.1 | 13.7 | — | 1.9 | — | D |
| 15-2 | 0.000 | 0.000 | 0.11 | 13.0 | 13.6 | 1% | 1.9 | 0% | D |

TABLE 2C

| | | | (Fe₁₋ₚ X1ₚ)_{Z} Mₐ B_{b} P_{c} Si_{d} Cₑ X2_{f} | | | | | | |
|---|---|---|---|---|---|---|---|---|---|
| | Example/ | | (d = e = f = 0, M:Nb) | | | | | | |
| Sample | Comparative | | Fe + X1 | X1 | | M(Nb) | B | P | Si |
| No. | Example | | Z | Type | p | a | b | c | d |
| 1-1 | Comparative | | 0.820 | Ni | 0.00 | 0.060 | 0.090 | 0.030 | 0.000 |
| | Example | | | | | | | | |
| 1-8 | Example | | 0.820 | Ni | 0.00 | 0.060 | 0.090 | 0.030 | 0.000 |
| 16-1 | Comparative | | 0.820 | Ni | 0.05 | 0.060 | 0.090 | 0.030 | 0.000 |
| | Example | | | | | | | | |
| 16-2 | Example | | 0.820 | Ni | 0.05 | 0.060 | 0.090 | 0.030 | 0.000 |
| 17-1 | Comparative | | 0.820 | Ni | 0.10 | 0.060 | 0.090 | 0.030 | 0.000 |
| | Example | | | | | | | | |
| 17-2 | Example | | 0.820 | Ni | 0.10 | 0.060 | 0.090 | 0.030 | 0.000 |
| 18-1 | Comparative | | 0.820 | Ni | 0.25 | 0.060 | 0.090 | 0.030 | 0.000 |
| | Example | | | | | | | | |
| 18-2 | Example | | 0.820 | Ni | 0.25 | 0.060 | 0.090 | 0.030 | 0.000 |
| 19-1 | Comparative | | 0.820 | Ni | 0.40 | 0.060 | 0.090 | 0.030 | 0.000 |
| | Example | | | | | | | | |
| 19-2 | Example | | 0.820 | Ni | 0.40 | 0.060 | 0.090 | 0.030 | 0.000 |
| 20-1 | Comparative | | 0.820 | Ni | 0.50 | 0.060 | 0.090 | 0.030 | 0.000 |
| | Example | | | | | | | | |
| 20-2 | Example | | 0.820 | Ni | 0.50 | 0.060 | 0.090 | 0.030 | 0.000 |
| 21-1 | Comparative | | 0.820 | Ni | 0.60 | 0.060 | 0.090 | 0.030 | 0.000 |
| | Example | | | | | | | | |
| 21-2 | Comparative | | 0.820 | Ni | 0.60 | 0.060 | 0.090 | 0.030 | 0.000 |
| | Example | | | | | | | | |
| | (Fe₁₋ₚ X1ₚ)_{Z} Mₐ B_{b} | | | | | | | | |
| | P_{c} Si_{d} Cₑ X2_{f} | | | Crystal | | | | | |
| | (d = e = f = 0, M:Nb) | | Around | Grain | | | Permeability | | |
| Sample | C | X2 | 65° | Size | Coercivity | Coercivity | (×10³) | Permeability | |
| No. | e | f | \|Δθ₁₂\| | (nm) | (A/m) | Improvement | [1 kHz] | Improvement | Grade |
| 1-1 | 0.000 | 0.000 | 0.00 | 11.3 | 7.3 | — | 18.2 | — | D |
| 1-8 | 0.000 | 0.000 | 0.11 | 11.4 | 4.3 | 41% | 23.8 | 31% | A |
| 16-1 | 0.000 | 0.000 | 0.00 | 12.7 | 9.2 | — | 15.6 | — | D |
| 16-2 | 0.000 | 0.000 | 0.06 | 12.6 | 6.5 | 29% | 19.8 | 27% | A |
| 17-1 | 0.000 | 0.000 | 0.00 | 12.5 | 9.7 | — | 13.0 | — | D |
| 17-2 | 0.000 | 0.000 | 0.07 | 12.7 | 6.6 | 32% | 16.4 | 26% | A |
| 18-1 | 0.000 | 0.000 | 0.00 | 12.7 | 9.8 | — | 9.9 | — | D |
| 18-2 | 0.000 | 0.000 | 0.08 | 12.9 | 6.9 | 30% | 12.8 | 29% | A |
| 19-1 | 0.000 | 0.000 | 0.00 | 12.5 | 9.4 | — | 8.0 | — | D |
| 19-2 | 0.000 | 0.000 | 0.06 | 12.7 | 7.0 | 26% | 10.2 | 28% | A |
| 20-1 | 0.000 | 0.000 | 0.00 | 12.7 | 8.9 | — | 4.9 | — | D |
| 20-2 | 0.000 | 0.000 | 0.11 | 12.5 | 6.8 | 24% | 6.0 | 22% | A |
| 21-1 | 0.000 | 0.000 | 0.00 | 12.9 | 9.5 | — | 3.8 | — | D |
| 21-2 | 0.000 | 0.000 | 0.13 | 13.3 | 9.4 | 1% | 3.9 | 3% | D |

TABLE 2D

| | | | (Fe₁₋ₚ X1ₚ)_{Z} Mₐ B_{b} P_{c} Si_{d} Cₑ X2_{f} | | | | | | |
|---|---|---|---|---|---|---|---|---|---|
| | Example/ | | (p1 + p2 = p, d = e = f = 0, M:Nb) | | | | | | |
| Sample | Comparative | | Fe + X1 | Co | Ni | M(Nb) | B | P | Si |
| No. | Example | | Z | p1 | p2 | a | b | c | d |
| 1-1 | Comparative | | 0.820 | 0.00 | 0.00 | 0.060 | 0.090 | 0.030 | 0.000 |
| | Example | | | | | | | | |
| 1-8 | Example | | 0.820 | 0.00 | 0.00 | 0.060 | 0.090 | 0.030 | 0.000 |
| 22-1 | Comparative | | 0.820 | 0.05 | 0.05 | 0.060 | 0.090 | 0.030 | 0.000 |
| | Example | | | | | | | | |
| 22-2 | Example | | 0.820 | 0.05 | 0.05 | 0.060 | 0.090 | 0.030 | 0.000 |
| 23-1 | Comparative | | 0.820 | 0.05 | 0.15 | 0.060 | 0.090 | 0.030 | 0.000 |
| | Example | | | | | | | | |
| 23-2 | Example | | 0.820 | 0.05 | 0.15 | 0.060 | 0.090 | 0.030 | 0.000 |
| 24-1 | Comparative | | 0.820 | 0.10 | 0.10 | 0.060 | 0.090 | 0.030 | 0.000 |
| | Example | | | | | | | | |
| 24-2 | Example | | 0.820 | 0.10 | 0.10 | 0.060 | 0.090 | 0.030 | 0.000 |
| 25-1 | Comparative | | 0.820 | 0.15 | 0.05 | 0.060 | 0.090 | 0.030 | 0.000 |
| | Example | | | | | | | | |
| 25-2 | Example | | 0.820 | 0.15 | 0.05 | 0.060 | 0.090 | 0.030 | 0.000 |
| 26-1 | Comparative | | 0.820 | 0.05 | 0.25 | 0.060 | 0.090 | 0.030 | 0.000 |
| | Example | | | | | | | | |
| 26-2 | Example | | 0.820 | 0.05 | 0.25 | 0.060 | 0.090 | 0.030 | 0.000 |
| 27-1 | Comparative | | 0.820 | 0.15 | 0.15 | 0.060 | 0.090 | 0.030 | 0.000 |
| | Example | | | | | | | | |
| 27-2 | Example | | 0.820 | 0.15 | 0.15 | 0.060 | 0.090 | 0.030 | 0.000 |
| 28-1 | Comparative | | 0.820 | 0.25 | 0.05 | 0.060 | 0.090 | 0.030 | 0.000 |
| | Example | | | | | | | | |
| 28-2 | Example | | 0.820 | 0.25 | 0.05 | 0.060 | 0.090 | 0.030 | 0.000 |
| 29-1 | Comparative | | 0.820 | 0.25 | 0.25 | 0.060 | 0.090 | 0.030 | 0.000 |
| | Example | | | | | | | | |
| 29-2 | Example | | 0.820 | 0.25 | 0.25 | 0.060 | 0.090 | 0.030 | 0.000 |
| | (Fe₁₋ₚ X1ₚ)_{Z} Mₐ B_{b} | | | | | | | | |
| | P_{c} Si_{d} Cₑ X2_{f} | | | | | | | | |
| | (p1 + p2 = p, d = | | | Crystal | | | | | |
| | e = f = 0, M:Nb) | | Around | Grain | | | Permeability | | |
| Sample | C | X2 | 65° | Size | Coercivity | Coercivity | (×10³) | Permeability | |
| No. | e | f | \|Δθ₁₂\| | (nm) | (A/m) | Improvement | [1 kHz] | Improvement | Grade |
| 1-1 | 0.000 | 0.000 | 0.00 | 11.3 | 7.3 | — | 18.2 | — | D |
| 1-8 | 0.000 | 0.000 | 0.11 | 11.4 | 4.3 | 41% | 23.8 | 31% | A |
| 22-1 | 0.000 | 0.000 | 0.00 | 12.3 | 10.9 | — | 15.9 | — | D |
| 22-2 | 0.000 | 0.000 | 0.12 | 12.6 | 7.7 | 29% | 20.3 | 28% | A |
| 23-1 | 0.000 | 0.000 | 0.00 | 12.4 | 11.5 | — | 14.3 | — | D |
| 23-2 | 0.000 | 0.000 | 0.18 | 12.5 | 8.4 | 27% | 18.1 | 27% | A |
| 24-1 | 0.000 | 0.000 | 0.00 | 12.7 | 13.2 | — | 13.1 | — | D |
| 24-2 | 0.000 | 0.000 | 0.14 | 12.6 | 9.7 | 27% | 16.6 | 27% | A |
| 25-1 | 0.000 | 0.000 | 0.00 | 12.5 | 11.6 | — | 12.9 | — | D |
| 25-2 | 0.000 | 0.000 | 0.14 | 12.4 | 8.5 | 27% | 16.2 | 26% | A |
| 26-1 | 0.000 | 0.000 | 0.00 | 12.8 | 11.3 | — | 10.3 | — | D |
| 26-2 | 0.000 | 0.000 | 0.20 | 12.7 | 8.6 | 24% | 12.7 | 23% | A |
| 27-1 | 0.000 | 0.000 | 0.00 | 12.5 | 11.2 | — | 9.5 | — | D |
| 27-2 | 0.000 | 0.000 | 0.16 | 12.4 | 8.5 | 24% | 11.8 | 24% | A |
| 28-1 | 0.000 | 0.000 | 0.00 | 12.7 | 11.5 | — | 8.5 | — | D |
| 28-2 | 0.000 | 0.000 | 0.18 | 12.8 | 8.7 | 24% | 10.5 | 24% | A |
| 29-1 | 0.000 | 0.000 | 0.00 | 13.0 | 11.7 | — | 6.4 | — | D |
| 29-2 | 0.000 | 0.000 | 0.17 | 13.1 | 9.1 | 22% | 7.8 | 22% | A |

TABLE 3A

| | | (Fe₁₋ₚ X1ₚ)_{Z} Mₐ B_{b} P_{c} Si_{d} Cₑ X2_{f} | | | | | | |
|---|---|---|---|---|---|---|---|---|
| | Example/ | (p = 0, d = e = f = 0) | | | | | | |
| Sample | Comparative | Fe | M | | B | P | Si | C |
| No. | Example | Z | Type | a | b | c | d | e |
| 30-1 | Comparative | 0.880 | Nb | 0.000 | 0.090 | 0.030 | 0.000 | 0.000 |
| | Example | | | | | | | |
| 30-2 | Example | 0.880 | Nb | 0.000 | 0.090 | 0.030 | 0.000 | 0.000 |
| 31-1 | Comparative | 0.870 | Nb | 0.010 | 0.090 | 0.030 | 0.000 | 0.000 |
| | Example | | | | | | | |
| 31-2 | Example | 0.870 | Nb | 0.010 | 0.090 | 0.030 | 0.000 | 0.000 |
| 32-1 | Comparative | 0.860 | Nb | 0.020 | 0.090 | 0.030 | 0.000 | 0.000 |
| | Example | | | | | | | |
| 32-2 | Example | 0.860 | Nb | 0.020 | 0.090 | 0.030 | 0.000 | 0.000 |
| 6-1 | Comparative | 0.840 | Nb | 0.040 | 0.090 | 0.030 | 0.000 | 0.000 |
| | Example | | | | | | | |
| 6-2 | Example | 0.840 | Nb | 0.040 | 0.090 | 0.030 | 0.000 | 0.000 |
| 33-1 | Comparative | 0.830 | Nb | 0.050 | 0.090 | 0.030 | 0.000 | 0.000 |
| | Example | | | | | | | |
| 33-2 | Example | 0.830 | Nb | 0.050 | 0.090 | 0.030 | 0.000 | 0.000 |
| 1-1 | Comparative | 0.820 | Nb | 0.060 | 0.090 | 0.030 | 0.000 | 0.000 |
| | Example | | | | | | | |
| 1-8 | Example | 0.820 | Nb | 0.060 | 0.090 | 0.030 | 0.000 | 0.000 |
| 34-1 | Comparative | 0.800 | Nb | 0.080 | 0.090 | 0.030 | 0.000 | 0.000 |
| | Example | | | | | | | |
| 34-2 | Example | 0.800 | Nb | 0.080 | 0.090 | 0.030 | 0.000 | 0.000 |
| 35-1 | Comparative | 0.780 | Nb | 0.100 | 0.090 | 0.030 | 0.000 | 0.000 |
| | Example | | | | | | | |
| 35-2 | Example | 0.780 | Nb | 0.100 | 0.090 | 0.030 | 0.000 | 0.000 |
| 36-1 | Comparative | 0.770 | Nb | 0.110 | 0.090 | 0.030 | 0.000 | 0.000 |
| | Example | | | | | | | |
| 36-2 | Comparative | 0.770 | Nb | 0.110 | 0.090 | 0.030 | 0.000 | 0.000 |
| | Example | | | | | | | |
| | (Fe₁₋ₚ X1ₚ)_{Z} Mₐ B_{b} | | | | | | | |
| | P_{c} Si_{d} Cₑ X2_{f} | | Crystal | | | | | |
| | (p = 0, d = e = f = 0) | Around | Grain | | | Permeability | | |
| Sample | X2 | 65° | Size | Coercivity | Coercivity | (×10³) | Permeability | |
| No. | f | \|Δθ₁₂\| | (nm) | (A/m) | Improvement | [1 kHz] | Improvement | Grade |
| 30-1 | 0.000 | 0.00 | 29.7 | 24.3 | — | 5.8 | — | D |
| 30-2 | 0.000 | 0.15 | 30.1 | 22.9 | 6% | 6.1 | 5% | C |
| 31-1 | 0.000 | 0.00 | 18.3 | 11.8 | — | 12.5 | — | D |
| 31-2 | 0.000 | 0.12 | 18.1 | 10.9 | 8% | 13.4 | 7% | C |
| 32-1 | 0.000 | 0.00 | 15.5 | 14.6 | — | 14.2 | — | D |
| 32-2 | 0.000 | 0.18 | 15.3 | 11.6 | 21% | 17.2 | 21% | A |
| 6-1 | 0.000 | 0.00 | 13.7 | 13.8 | — | 15.9 | — | D |
| 6-2 | 0.000 | 0.20 | 13.5 | 10.1 | 27% | 20.3 | 28% | A |
| 33-1 | 0.000 | 0.00 | 12.4 | 8.2 | — | 16.3 | — | D |
| 33-2 | 0.000 | 0.15 | 12.4 | 6.1 | 26% | 20.7 | 27% | A |
| 1-1 | 0.000 | 0.00 | 11.3 | 7.3 | | 18.2 | | D |
| 1-8 | 0.000 | 0.11 | 11.4 | 4.3 | 41% | 23.8 | 31% | A |
| 34-1 | 0.000 | 0.00 | 10.3 | 6.9 | — | 17.1 | — | D |
| 34-2 | 0.000 | 0.17 | 9.9 | 5.1 | 26% | 20.8 | 22% | A |
| 35-1 | 0.000 | 0.00 | 8.9 | 7.2 | — | 17.9 | — | D |
| 35-2 | 0.000 | 0.13 | 8.7 | 6.1 | 15% | 20.1 | 12% | B |
| 36-1 | 0.000 | 0.00 | 8.4 | 7.5 | — | 14.2 | — | D |
| 36-2 | 0.000 | 0.17 | 8.5 | 7.4 | 1% | 14.3 | 1% | D |

TABLE 3B

| | | (Fe₁₋ₚ X1ₚ)_{Z} Mₐ B_{b} P_{c} Si_{d} Cₑ X2_{f} | | | | | | |
|---|---|---|---|---|---|---|---|---|
| | Example/ | (p = 0, d = e = f = 0) | | | | | | |
| Sample | Comparative | Fe | M | | B | P | Si | C |
| No. | Example | Z | Type | a | b | c | d | e |
| 37-1 | Comparative | 0.860 | Hf | 0.020 | 0.090 | 0.030 | 0.000 | 0.000 |
| | Example | | | | | | | |
| 37-2 | Example | 0.860 | Hf | 0.020 | 0.090 | 0.030 | 0.000 | 0.000 |
| 38-1 | Comparative | 0.850 | Hf | 0.030 | 0.090 | 0.030 | 0.000 | 0.000 |
| | Example | | | | | | | |
| 38-2 | Example | 0.850 | Hf | 0.030 | 0.090 | 0.030 | 0.000 | 0.000 |
| 39-1 | Comparative | 0.835 | Hf | 0.045 | 0.090 | 0.030 | 0.000 | 0.000 |
| | Example | | | | | | | |
| 39-2 | Example | 0.835 | Hf | 0.045 | 0.090 | 0.030 | 0.000 | 0.000 |
| 40-1 | Comparative | 0.820 | Hf | 0.060 | 0.090 | 0.030 | 0.000 | 0.000 |
| | Example | | | | | | | |
| 40-2 | Example | 0.820 | Hf | 0.060 | 0.090 | 0.030 | 0.000 | 0.000 |
| 41-1 | Comparative | 0.800 | Hf | 0.080 | 0.090 | 0.030 | 0.000 | 0.000 |
| | Example | | | | | | | |
| 41-2 | Example | 0.800 | Hf | 0.080 | 0.090 | 0.030 | 0.000 | 0.000 |
| 42-1 | Comparative | 0.780 | Hf | 0.100 | 0.090 | 0.030 | 0.000 | 0.000 |
| | Example | | | | | | | |
| 42-2 | Example | 0.780 | Hf | 0.100 | 0.090 | 0.030 | 0.000 | 0.000 |
| 43-1 | Comparative | 0.860 | Zr | 0.020 | 0.090 | 0.030 | 0.000 | 0.000 |
| | Example | | | | | | | |
| 43-2 | Example | 0.860 | Zr | 0.020 | 0.090 | 0.030 | 0.000 | 0.000 |
| 44-1 | Comparative | 0.850 | Zr | 0.030 | 0.090 | 0.030 | 0.000 | 0.000 |
| | Example | | | | | | | |
| 44-2 | Example | 0.850 | Zr | 0.030 | 0.090 | 0.030 | 0.000 | 0.000 |
| 45-1 | Comparative | 0.835 | Zr | 0.045 | 0.090 | 0.030 | 0.000 | 0.000 |
| | Example | | | | | | | |
| 45-2 | Example | 0.835 | Zr | 0.045 | 0.090 | 0.030 | 0.000 | 0.000 |
| 46-1 | Comparative | 0.820 | Zr | 0.060 | 0.090 | 0.030 | 0.000 | 0.000 |
| | Example | | | | | | | |
| 46-2 | Example | 0.820 | Zr | 0.060 | 0.090 | 0.030 | 0.000 | 0.000 |
| 47-1 | Comparative | 0.800 | Zr | 0.080 | 0.090 | 0.030 | 0.000 | 0.000 |
| | Example | | | | | | | |
| 47-2 | Example | 0.800 | Zr | 0.080 | 0.090 | 0.030 | 0.000 | 0.000 |
| 48-1 | Comparative | 0.780 | Zr | 0.100 | 0.090 | 0.030 | 0.000 | 0.000 |
| | Example | | | | | | | |
| 48-2 | Example | 0.780 | Zr | 0.100 | 0.090 | 0.030 | 0.000 | 0.000 |
| | (Fe₁₋ₚ X1ₚ)_{Z} Mₐ B_{b} | | | | | | | |
| | P_{c} Si_{d} Cₑ X2_{f} | | Crystal | | | | | |
| | (p = 0, d = e = f = 0) | Around | Grain | | | Permeability | | |
| Sample | X2 | 65° | Size | Coercivity | Coercivity | (×10³) | Permeability | |
| No. | f | \|Δθ₁₂\| | (nm) | (A/m) | Improvement | [1 kHz] | Improvement | Grade |
| 37-1 | 0.000 | 0.00 | 19.4 | 18.3 | — | 8.4 | — | D |
| 37-2 | 0.000 | 0.12 | 18.9 | 14.4 | 21% | 10.1 | 20% | A |
| 38-1 | 0.000 | 0.00 | 18.1 | 17.4 | — | 9.9 | — | D |
| 38-2 | 0.000 | 0.12 | 18.3 | 13.2 | 24% | 12.2 | 23% | A |
| 39-1 | 0.000 | 0.00 | 16.1 | 15.3 | — | 11.7 | — | D |
| 39-2 | 0.000 | 0.19 | 15.8 | 11.2 | 27% | 14.8 | 26% | A |
| 40-1 | 0.000 | 0.00 | 13.8 | 10.4 | — | 14.2 | — | D |
| 40-2 | 0.000 | 0.20 | 13.4 | 7.0 | 33% | 18.8 | 32% | A |
| 41-1 | 0.000 | 0.00 | 12.4 | 8.6 | — | 14.9 | — | D |
| 41-2 | 0.000 | 0.14 | 12.3 | 6.6 | 23% | 18.2 | 22% | A |
| 42-1 | 0.000 | 0.00 | 9.2 | 8.1 | — | 14.7 | — | D |
| 42-2 | 0.000 | 0.19 | 9.5 | 6.8 | 16% | 16.9 | 15% | B |
| 43-1 | 0.000 | 0.00 | 20.1 | 17.1 | — | 8.2 | — | D |
| 43-2 | 0.000 | 0.17 | 19.6 | 13.7 | 20% | 9.9 | 21% | A |
| 44-1 | 0.000 | 0.00 | 17.4 | 16.4 | — | 9.3 | — | D |
| 44-2 | 0.000 | 0.12 | 17.1 | 12.7 | 23% | 11.3 | 22% | A |
| 45-1 | 0.000 | 0.00 | 14.9 | 13.8 | — | 12.0 | — | D |
| 45-2 | 0.000 | 0.20 | 15.0 | 10.3 | 25% | 14.9 | 24% | A |
| 46-1 | 0.000 | 0.00 | 12.2 | 11.3 | — | 14.7 | — | D |
| 46-2 | 0.000 | 0.15 | 12.5 | 7.8 | 31% | 19.1 | 30% | A |
| 47-1 | 0.000 | 0.00 | 11.5 | 10.8 | — | 15.0 | — | D |
| 47-2 | 0.000 | 0.17 | 11.2 | 7.9 | 27% | 18.9 | 26% | A |
| 48-1 | 0.000 | 0.00 | 10.1 | 10.2 | — | 14.9 | — | D |
| 48-2 | 0.000 | 0.09 | 10.3 | 8.5 | 17% | 17.2 | 15% | B |

TABLE 3C

| | | (Fe₁₋ₚ X1ₚ)_{Z} Mₐ B_{b} P_{c} Si_{d} Cₑ X2_{f} | | | | | | |
|---|---|---|---|---|---|---|---|---|
| | Example/ | (p = 0, d = e = f = 0) | | | | | | |
| Sample | Comparative | Fe | M | | B | P | Si | C |
| No. | Example | Z | Type | a | b | c | d | e |
| 49-1 | Comparative | 0.820 | Ta | 0.060 | 0.090 | 0.030 | 0.000 | 0.000 |
| | Example | | | | | | | |
| 49-2 | Example | 0.820 | Ta | 0.060 | 0.090 | 0.030 | 0.000 | 0.000 |
| 50-1 | Comparative | 0.820 | Ti | 0.060 | 0.090 | 0.030 | 0.000 | 0.000 |
| | Example | | | | | | | |
| 50-2 | Example | 0.820 | Ti | 0.060 | 0.090 | 0.030 | 0.000 | 0.000 |
| 51-1 | Comparative | 0.820 | Mo | 0.060 | 0.090 | 0.030 | 0.000 | 0.000 |
| | Example | | | | | | | |
| 51-2 | Example | 0.820 | Mo | 0.060 | 0.090 | 0.030 | 0.000 | 0.000 |
| 52-1 | Comparative | 0.820 | W | 0.060 | 0.090 | 0.030 | 0.000 | 0.000 |
| | Example | | | | | | | |
| 52-2 | Example | 0.820 | W | 0.060 | 0.090 | 0.030 | 0.000 | 0.000 |
| 53-1 | Comparative | 0.820 | Mn | 0.060 | 0.090 | 0.030 | 0.000 | 0.000 |
| | Example | | | | | | | |
| 53-2 | Example | 0.820 | Mn | 0.060 | 0.090 | 0.030 | 0.000 | 0.000 |
| 54-1 | Comparative | 0.820 | V | 0.060 | 0.090 | 0.030 | 0.000 | 0.000 |
| | Example | | | | | | | |
| 54-2 | Example | 0.820 | V | 0.060 | 0.090 | 0.030 | 0.000 | 0.000 |
| | (Fe₁₋ₚ X1ₚ)_{Z} Mₐ B_{b} | | | | | | | |
| | P_{c} Si_{d} Cₑ X2_{f} | | Crystal | | | | | |
| | (p = 0, d = e = f = 0) | Around | Grain | | | Permeability | | |
| Sample | X2 | 65° | Size | Coercivity | Coercivity | (×10³) | Permeability | |
| No. | f | \|Δθ₁₂\| | (nm) | (A/m) | Improvement | [1 kHz] | Improvement | Grade |
| 49-1 | 0.000 | 0.00 | 13.1 | 12.5 | — | 11.4 | — | D |
| 49-2 | 0.000 | 0.16 | 13.3 | 9.7 | 22% | 14.3 | 25% | A |
| 50-1 | 0.000 | 0.00 | 13.9 | 20.7 | — | 6.3 | — | D |
| 50-2 | 0.000 | 0.11 | 13.6 | 15.1 | 27% | 8.2 | 30% | A |
| 51-1 | 0.000 | 0.00 | 11.9 | 16.2 | — | 9.7 | — | D |
| 51-2 | 0.000 | 0.21 | 12.0 | 11.7 | 28% | 12.5 | 29% | A |
| 52-1 | 0.000 | 0.00 | 12.9 | 16.4 | — | 11.8 | — | D |
| 52-2 | 0.000 | 0.16 | 12.7 | 12.6 | 23% | 14.5 | 23% | A |
| 53-1 | 0.000 | 0.00 | 14.1 | 16.8 | — | 11.0 | — | D |
| 53-2 | 0.000 | 0.17 | 14.2 | 12.4 | 26% | 14.1 | 28% | A |
| 54-1 | 0.000 | 0.00 | 13.7 | 17.9 | — | 9.4 | — | D |
| 54-2 | 0.000 | 0.15 | 13.6 | 13.1 | 27% | 11.8 | 26% | A |

TABLE 3D

| | | (Fe₁₋ₚ X1ₚ)_{Z} Mₐ B_{b} P_{c} Si_{d} Cₑ X2_{f} | | | | | | | | |
|---|---|---|---|---|---|---|---|---|---|---|
| | Example/ | (p = 0, d = e = f = 0, a1 + a2 + a3 = a) | | | | | | | | |
| Sample | Comparative | Fe | M | | | | | | B | P |
| No. | Example | Z | Type | a1 | Type | a2 | Type | a3 | b | c |
| 55-1 | Comparative | 0.820 | Nb | 0.015 | Zr | 0.045 | — | 0.000 | 0.090 | 0.030 |
| | Example | | | | | | | | | |
| 55-2 | Example | 0.820 | Nb | 0.015 | Zr | 0.045 | — | 0.000 | 0.090 | 0.030 |
| 56-1 | Comparative | 0.820 | Nb | 0.030 | Zr | 0.030 | — | 0.000 | 0.090 | 0.030 |
| | Example | | | | | | | | | |
| 56-2 | Example | 0.820 | Nb | 0.030 | Zr | 0.030 | — | 0.000 | 0.090 | 0.030 |
| 57-1 | Comparative | 0.820 | Nb | 0.045 | Zr | 0.015 | — | 0.000 | 0.090 | 0.030 |
| | Example | | | | | | | | | |
| 57-2 | Example | 0.820 | Nb | 0.045 | Zr | 0.015 | — | 0.000 | 0.090 | 0.030 |
| 58-1 | Comparative | 0.820 | Nb | 0.015 | Hf | 0.045 | — | 0.000 | 0.090 | 0.030 |
| | Example | | | | | | | | | |
| 58-2 | Example | 0.820 | Nb | 0.015 | Hf | 0.045 | — | 0.000 | 0.090 | 0.030 |
| 59-1 | Comparative | 0.820 | Nb | 0.030 | Hf | 0.030 | — | 0.000 | 0.090 | 0.030 |
| | Example | | | | | | | | | |
| 59-2 | Example | 0.820 | Nb | 0.030 | Hf | 0.030 | — | 0.000 | 0.090 | 0.030 |
| 60-1 | Comparative | 0.820 | Nb | 0.045 | Hf | 0.015 | — | 0.000 | 0.090 | 0.030 |
| | Example | | | | | | | | | |
| 60-2 | Example | 0.820 | Nb | 0.045 | Hf | 0.015 | — | 0.000 | 0.090 | 0.030 |
| 61-1 | Comparative | 0.820 | Zr | 0.015 | Hf | 0.045 | — | 0.000 | 0.090 | 0.030 |
| | Example | | | | | | | | | |
| 61-2 | Example | 0.820 | Zr | 0.015 | Hf | 0.045 | — | 0.000 | 0.090 | 0.030 |
| 62-1 | Comparative | 0.820 | Zr | 0.030 | Hf | 0.030 | — | 0.000 | 0.090 | 0.030 |
| | Example | | | | | | | | | |
| 62-2 | Example | 0.820 | Zr | 0.030 | Hf | 0.030 | — | 0.000 | 0.090 | 0.030 |
| 63-1 | Comparative | 0.820 | Zr | 0.045 | Hf | 0.015 | — | 0.000 | 0.090 | 0.030 |
| | Example | | | | | | | | | |
| 63-2 | Example | 0.820 | Zr | 0.045 | Hf | 0.015 | — | 0.000 | 0.090 | 0.030 |
| | (Fe₁₋ₚ X1ₚ)_{Z} Mₐ B_{b} P_{c} Si_{d} Cₑ X2_{f} | | | | Crystal | | Coer- | Perme- | Perme- | |
| | (p = 0, d = e = f = 0, a1 + a2 + a3 = a) | | | Around | Grain | Coer- | civity | ability | ability | |
| Sample | Si | C | X2 | 65° | Size | civity | Improve- | (×10³) | Improve- | |
| No. | d | e | f | \|Δθ₁₂\| | (nm) | (A/m) | ment | [1 kHz] | ment | Grade |
| 55-1 | 0.000 | 0.000 | 0.000 | 0.00 | 12.3 | 9.4 | — | 15.0 | — | D |
| 55-2 | 0.000 | 0.000 | 0.000 | 0.16 | 12.4 | 6.7 | 29% | 19.2 | 28% | A |
| 56-1 | 0.000 | 0.000 | 0.000 | 0.00 | 12.6 | 8.8 | — | 15.7 | — | D |
| 56-2 | 0.000 | 0.000 | 0.000 | 0.17 | 12.6 | 6.1 | 31% | 20.4 | 30% | A |
| 57-1 | 0.000 | 0.000 | 0.000 | 0.00 | 11.9 | 8.5 | — | 16.0 | — | D |
| 57-2 | 0.000 | 0.000 | 0.000 | 0.10 | 12.0 | 5.7 | 33% | 21.3 | 33% | A |
| 58-1 | 0.000 | 0.000 | 0.000 | 0.00 | 12.9 | 9.2 | — | 14.7 | — | D |
| 58-2 | 0.000 | 0.000 | 0.000 | 0.10 | 12.8 | 6.7 | 27% | 18.8 | 28% | A |
| 59-1 | 0.000 | 0.000 | 0.000 | 0.00 | 12.3 | 8.2 | — | 15.9 | — | D |
| 59-2 | 0.000 | 0.000 | 0.000 | 0.16 | 12.5 | 5.8 | 29% | 20.8 | 31% | A |
| 60-1 | 0.000 | 0.000 | 0.000 | 0.00 | 11.8 | 8.6 | — | 15.5 | — | D |
| 60-2 | 0.000 | 0.000 | 0.000 | 0.13 | 11.8 | 5.6 | 35% | 21.2 | 37% | A |
| 61-1 | 0.000 | 0.000 | 0.000 | 0.00 | 13.5 | 9.9 | — | 15.6 | — | D |
| 61-2 | 0.000 | 0.000 | 0.000 | 0.11 | 13.6 | 6.9 | 30% | 20.3 | 30% | A |
| 62-1 | 0.000 | 0.000 | 0.000 | 0.00 | 13.2 | 9.1 | — | 16.0 | — | D |
| 62-2 | 0.000 | 0.000 | 0.000 | 0.13 | 13.0 | 6.5 | 29% | 20.8 | 30% | A |
| 63-1 | 0.000 | 0.000 | 0.000 | 0.00 | 12.8 | 8.8 | — | 15.7 | — | D |
| 63-2 | 0.000 | 0.000 | 0.000 | 0.12 | 12.7 | 6.2 | 30% | 20.1 | 28% | A |

TABLE 3E

| | Ex- | | | | | | | | | | | | | | | | | | | |
|---|---|---|---|---|---|---|---|---|---|---|---|---|---|---|---|---|---|---|---|---|
| | ample/ | | | | | | | | | | | | | | | | | | | |
| | Com- | (Fe₁₋ₚ X1ₚ)_{Z} Mₐ B_{b} P_{c} Si_{d} Cₑ X2_{f} | | | | | | | | | | | | | | | | | | |
| | parative | (p = 0, d = e = f = 0, a1 + a2 + a3 = a) | | | | | | | | | | | | Around | Crystal | | Coercivity | Permeability | | |
| Sample | Ex- | Fe | M | | | | | | B | P | Si | C | X2 | 65° | Grain Size | Coercivity | Improve- | (× 10³) | Permeability | |
| No. | ample | Z | Type | a1 | Type | a2 | Type | a3 | b | C | d | e | f | \|Δθ₁₂\| | (nm) | (A/m) | ment | [1 kHz] | Improvement | Grade |
| 64-1 | Com- | 0.820 | Nb | 0.020 | Zr | 0.020 | Hf | 0.020 | 0.090 | 0.030 | 0.000 | 0.000 | 0.000 | 0.00 | 12.4 | 8.7 | — | 15.4 | — | D |
| | parative | | | | | | | | | | | | | | | | | | | |
| | Ex- | | | | | | | | | | | | | | | | | | | |
| | ample | | | | | | | | | | | | | | | | | | | |
| 64-2 | Ex- | 0.820 | Nb | 0.020 | Zr | 0.020 | Hf | 0.020 | 0.090 | 0.030 | 0.000 | 0.000 | 0.000 | 0.11 | 12.5 | 6.3 | 28% | 19.4 | 26% | A |
| | ample | | | | | | | | | | | | | | | | | | | |
| 65-1 | Com- | 0.820 | Nb | 0.030 | Zr | 0.020 | Hf | 0.010 | 0.090 | 0.030 | 0.000 | 0.000 | 0.000 | 0.00 | 12.7 | 8.7 | — | 15.9 | — | D |
| | parative | | | | | | | | | | | | | | | | | | | |
| | Ex- | | | | | | | | | | | | | | | | | | | |
| | ample | | | | | | | | | | | | | | | | | | | |
| 65-2 | Ex- | 0.820 | Nb | 0.030 | Zr | 0.020 | Hf | 0.010 | 0.090 | 0.030 | 0.000 | 0.000 | 0.000 | 0.08 | 12.7 | 6.1 | 30% | 20.5 | 29% | A |
| | ample | | | | | | | | | | | | | | | | | | | |
| 66-1 | Com- | 0.820 | Nb | 0.040 | Mn | 0.010 | V | 0.010 | 0.090 | 0.030 | 0.000 | 0.000 | 0.000 | 0.00 | 14.5 | 15.9 | — | 12.2 | — | D |
| | parative | | | | | | | | | | | | | | | | | | | |
| | Ex- | | | | | | | | | | | | | | | | | | | |
| | ample | | | | | | | | | | | | | | | | | | | |
| 66-2 | Ex- | 0.820 | Nb | 0.040 | Mn | 0.010 | V | 0.010 | 0.090 | 0.030 | 0.000 | 0.000 | 0.000 | 0.12 | 14.7 | 11.4 | 28% | 15.5 | 27% | A |
| | ample | | | | | | | | | | | | | | | | | | | |
| 67-1 | Com- | 0.820 | Nb | 0.040 | W | 0.010 | Mn | 0.010 | 0.090 | 0.030 | 0.000 | 0.000 | 0.000 | 0.00 | 13.3 | 16.2 | — | 12.2 | — | D |
| | parative | | | | | | | | | | | | | | | | | | | |
| | Ex- | | | | | | | | | | | | | | | | | | | |
| | ample | | | | | | | | | | | | | | | | | | | |
| 67-2 | Ex- | 0.820 | Nb | 0.040 | W | 0.010 | Mn | 0.010 | 0.090 | 0.030 | 0.000 | 0.000 | 0.000 | 0.16 | 13.1 | 11.9 | 27% | 15.4 | 26% | A |
| | ample | | | | | | | | | | | | | | | | | | | |
| 68-1 | Com- | 0.820 | Zr | 0.040 | Ti | 0.010 | V | 0.010 | 0.090 | 0.030 | 0.000 | 0.000 | 0.000 | 0.00 | 12.6 | 15.9 | — | 12.1 | — | D |
| | parative | | | | | | | | | | | | | | | | | | | |
| | Ex- | | | | | | | | | | | | | | | | | | | |
| | ample | | | | | | | | | | | | | | | | | | | |
| 68-2 | Ex- | 0.820 | Zr | 0.040 | Ti | 0.010 | V | 0.010 | 0.090 | 0.030 | 0.000 | 0.000 | 0.000 | 0.11 | 12.5 | 12.4 | 22% | 14.8 | 22% | A |
| | ample | | | | | | | | | | | | | | | | | | | |
| 69-1 | Com- | 0.820 | Hf | 0.040 | Ta | 0.010 | Mo | 0.010 | 0.090 | 0.030 | 0.000 | 0.000 | 0.000 | 0.00 | 10.9 | 16.7 | — | 12.6 | — | D |
| | parative | | | | | | | | | | | | | | | | | | | |
| | Ex- | | | | | | | | | | | | | | | | | | | |
| | ample | | | | | | | | | | | | | | | | | | | |
| 69-2 | Ex- | 0.820 | Hf | 0.040 | Ta | 0.010 | Mo | 0.010 | 0.090 | 0.030 | 0.000 | 0.000 | 0.000 | 0.13 | 10.8 | 12.6 | 25% | 15.6 | 24% | A |
| | ample | | | | | | | | | | | | | | | | | | | |

TABLE 4

| | | (Fe₁₋ₚ X1ₚ)_{Z} Mₐ B_{b} P_{c} Si_{d} Cₑ X2_{f} | | | | | | | | Crystal | | Coer- | Perme- | Perme- | |
|---|---|---|---|---|---|---|---|---|---|---|---|---|---|---|---|
| | Example/ | (p = 0, d = e = f = 0, M:Nb) | | | | | | | Around | Grain | Coer- | civity | ability | ability | |
| Sample | Comparative | Fe | M (Nb) | B | P | Si | C | X2 | 65° | Size | civity | Improve- | (× 10³) | Improve- | |
| No. | Example | Z | a | b | C | d | e | f | \|Δθ₁₂\| | (nm) | (A/m) | ment | [1 kHz] | ment | Grade |
| 70-1 | Comparative | 0.900 | 0.060 | 0.010 | 0.030 | 0.000 | 0.000 | 0.000 | 0.00 | 21.5 | 13.1 | — | 11.6 | — | D |
| | Example | | | | | | | | | | | | | | |
| 70-2 | Comparative | 0.900 | 0.060 | 0.010 | 0.030 | 0.000 | 0.000 | 0.000 | 0.15 | 21.4 | 13.2 | −1% | 11.6 | 0% | D |
| | Example | | | | | | | | | | | | | | |
| 71-1 | Comparative | 0.890 | 0.060 | 0.020 | 0.030 | 0.000 | 0.000 | 0.000 | 0.00 | 14.6 | 13.9 | — | 11.9 | — | D |
| | Example | | | | | | | | | | | | | | |
| 71-2 | Example | 0.890 | 0.060 | 0.020 | 0.030 | 0.000 | 0.000 | 0.000 | 0.14 | 14.6 | 12.6 | 9% | 12.8 | 8% | C |
| 72-1 | Comparative | 0.850 | 0.060 | 0.060 | 0.030 | 0.000 | 0.000 | 0.000 | 0.00 | 12.4 | 10.8 | — | 14.5 | — | D |
| | Example | | | | | | | | | | | | | | |
| 72-2 | Example | 0.850 | 0.060 | 0.060 | 0.030 | 0.000 | 0.000 | 0.000 | 0.09 | 12.3 | 9.2 | 15% | 16.9 | 17% | B |
| 73-1 | Comparative | 0.830 | 0.060 | 0.080 | 0.030 | 0.000 | 0.000 | 0.000 | 0.00 | 11.6 | 8.5 | — | 16.8 | | D |
| | Example | | | | | | | | | | | | | | |
| 73-2 | Example | 0.830 | 0.060 | 0.080 | 0.030 | 0.000 | 0.000 | 0.000 | 0.11 | 11.5 | 6.2 | 27% | 21.1 | 26% | A |
| 1-1 | Comparative | 0.820 | 0.060 | 0.090 | 0.030 | 0.000 | 0.000 | 0.000 | 0.00 | 11.3 | 7.3 | — | 18.2 | — | D |
| | Example | | | | | | | | | | | | | | |
| 1-8 | Example | 0.820 | 0.060 | 0.090 | 0.030 | 0.000 | 0.000 | 0.000 | 0.11 | 11.4 | 4.3 | 41% | 23.8 | 31% | |
| 74-1 | Comparative | 0.790 | 0.060 | 0.120 | 0.030 | 0.000 | 0.000 | 0.000 | 0.00 | 11.5 | 8.5 | — | 16.0 | — | |
| | Example | | | | | | | | | | | | | | |
| 74-2 | Example | 0.790 | 0.060 | 0.120 | 0.030 | 0.000 | 0.000 | 0.000 | 0.08 | 11.7 | 6.0 | 29% | 20.2 | 26% | A |
| 75-1 | Comparative | 0.730 | 0.060 | 0.180 | 0.030 | 0.000 | 0.000 | 0.000 | 0.00 | 11.4 | 11.0 | — | 13.9 | — | D |
| | Example | | | | | | | | | | | | | | |
| 75-2 | Example | 0.730 | 0.060 | 0.180 | 0.030 | 0.000 | 0.000 | 0.000 | 0.15 | 11.2 | 8.7 | 21% | 16.9 | 22% | A |
| 76-1 | Comparative | 0.710 | 0.060 | 0.200 | 0.030 | 0.000 | 0.000 | 0.000 | 0.00 | 11.9 | 13.4 | — | 11.5 | — | D |
| | Example | | | | | | | | | | | | | | |
| 76-2 | Example | 0.710 | 0.060 | 0.200 | 0.030 | 0.000 | 0.000 | 0.000 | 0.09 | 12.0 | 12.4 | 7% | 12.4 | 8% | C |
| 77-1 | Comparative | 0.700 | 0.060 | 0.210 | 0.030 | 0.000 | 0.000 | 0.000 | 0.00 | 12.3 | 13.8 | — | 10.7 | — | D |
| | Example | | | | | | | | | | | | | | |
| 77-2 | Comparative | 0.700 | 0.060 | 0.210 | 0.030 | 0.000 | 0.000 | 0.000 | 0.09 | 12.2 | 13.8 | 0% | 10.8 | 1% | D |
| | Example | | | | | | | | | | | | | | |

TABLE 5

| | | (Fe₁₋ₚ X1ₚ)_{Z} Mₐ B_{b} P_{c} Si_{d} Cₑ X2_{f} | | | | | | | | Crystal | | Coer- | Perme- | Perme- | |
|---|---|---|---|---|---|---|---|---|---|---|---|---|---|---|---|
| | Example/ | (p = 0, d = e = f = 0, M:Nb) | | | | | | | Around | Grain | Coer- | civity | ability | ability | |
| Sample | Comparative | Fe | M(Nb) | B | P | Si | C | X2 | 65° | Size | civity | Improve- | (× 10³) | Improve- | |
| No. | Example | Z | a | b | C | d | e | f | \|Δθ₁₂\| | (nm) | (A/m) | ment | [1 kHz] | ment | Grade |
| 78-1 | Comparative | 0.850 | 0.060 | 0.090 | 0.000 | 0.000 | 0.000 | 0.000 | 0.00 | 11.9 | 12.1 | — | 13.7 | — | D |
| | Example | | | | | | | | | | | | | | |
| 78-2 | Example | 0.850 | 0.060 | 0.090 | 0.000 | 0.000 | 0.000 | 0.000 | 0.14 | 11.7 | 10.8 | 11% | 15.2 | 11% | B |
| 79-1 | Comparative | 0.849 | 0.060 | 0.090 | 0.001 | 0.000 | 0.000 | 0.000 | 0.00 | 11.8 | 12.0 | — | 13.7 | — | D |
| | Example | | | | | | | | | | | | | | |
| 79-2 | Example | 0.849 | 0.060 | 0.090 | 0.001 | 0.000 | 0.000 | 0.000 | 0.12 | 11.8 | 10.4 | 13% | 15.7 | 15% | B |
| 80-1 | Comparative | 0.847 | 0.060 | 0.090 | 0.003 | 0.000 | 0.000 | 0.000 | 0.00 | 11.8 | 11.9 | | 13.9 | | D |
| | Example | | | | | | | | | | | | | | |
| 80-2 | Example | 0.847 | 0.060 | 0.090 | 0.003 | 0.000 | 0.000 | 0.000 | 0.16 | 11.7 | 9.4 | 21% | 17.1 | 23% | A |
| 81-1 | Comparative | 0.840 | 0.060 | 0.090 | 0.010 | 0.000 | 0.000 | 0.000 | 0.00 | 11.6 | 10.5 | — | 14.2 | — | D |
| | Example | | | | | | | | | | | | | | |
| 81-2 | Example | 0.840 | 0.060 | 0.090 | 0.010 | 0.000 | 0.000 | 0.000 | 0.20 | 11.6 | 7.6 | 28% | 17.9 | 26% | A |
| 1-1 | Comparative | 0.820 | 0.060 | 0.090 | 0.030 | 0.000 | 0.000 | 0.000 | 0.00 | 11.3 | 7.3 | — | 18.2 | — | D |
| | Example | | | | | | | | | | | | | | |
| 1-8 | Example | 0.820 | 0.060 | 0.090 | 0.030 | 0.000 | 0.000 | 0.000 | 0.11 | 11.4 | 4.3 | 41% | 23.8 | 31% | A |
| 82-1 | Comparative | 0.800 | 0.060 | 0.090 | 0.050 | 0.000 | 0.000 | 0.000 | 0.00 | 11.4 | 8.1 | — | 16.3 | — | D |
| | Example | | | | | | | | | | | | | | |
| 82-2 | Example | 0.800 | 0.060 | 0.090 | 0.050 | 0.000 | 0.000 | 0.000 | 0.15 | 11.5 | 5.7 | 30% | 20.8 | 28% | A |
| 83-1 | Comparative | 0.775 | 0.060 | 0.090 | 0.075 | 0.000 | 0.000 | 0.000 | 0.00 | 11.0 | 9.6 | — | 13.9 | — | D |
| | Example | | | | | | | | | | | | | | |
| 83-2 | Example | 0.775 | 0.060 | 0.090 | 0.075 | 0.000 | 0.000 | 0.000 | 0.14 | 11.1 | 7.2 | 25% | 17.3 | 24% | A |
| 84-1 | Comparative | 0.750 | 0.060 | 0.090 | 0.100 | 0.000 | 0.000 | 0.000 | 0.00 | 11.1 | 11.7 | — | 10.8 | — | D |
| | Example | | | | | | | | | | | | | | |
| 84-2 | Example | 0.750 | 0.060 | 0.090 | 0.100 | 0.000 | 0.000 | 0.000 | 0.13 | 11.2 | 9.2 | 21% | 13.2 | 22% | A |
| 85-1 | Comparative | 0.740 | 0.060 | 0.090 | 0.110 | 0.000 | 0.000 | 0.000 | 0.00 | 11.1 | 11.7 | — | 9.3 | — | D |
| | Example | | | | | | | | | | | | | | |
| 85-2 | Comparative | 0.740 | 0.060 | 0.090 | 0.110 | 0.000 | 0.000 | 0.000 | 0.09 | 11.3 | 11.6 | 1% | 9.3 | 0% | D |
| | Example | | | | | | | | | | | | | | |

TABLE 6

| | | (Fe₁₋ₚ X1ₚ)_{Z} Mₐ B_{b} P_{c} Si_{d} Cₑ X2_{f} | | | | | | | | Crystal | | Coer- | Perme- | Perme- | |
|---|---|---|---|---|---|---|---|---|---|---|---|---|---|---|---|
| | Example/ | (p = 0, e = f = 0, M:Nb) | | | | | | | Around | Grain | Coer- | civity | ability | ability | |
| Sample | Comparative | Fe | M(Nb) | B | P | Si | C | X2 | 65° | Size | civity | Improve | (× 10³) | Improve- | |
| No. | Example | Z | a | b | C | d | e | f | \|Δθ₁₂\| | (nm) | (A/m) | ment | [1kHz] | ment | Grade |
| 1-1 | Comparative | 0.820 | 0.060 | 0.090 | 0.030 | 0.000 | 0.000 | 0.000 | 0.00 | 11.3 | 7.3 | — | 18.2 | — | D |
| | Example | | | | | | | | | | | | | | |
| 1-8 | Example | 0.820 | 0.060 | 0.090 | 0.030 | 0.000 | 0.000 | 0.000 | 0.11 | 11.4 | 4.3 | 41% | 23.8 | 31% | A |
| 86-1 | Comparative | 0.810 | 0.060 | 0.090 | 0.030 | 0.010 | 0.000 | 0.000 | 0.00 | 11.5 | 8.4 | — | 17.0 | — | D |
| | Example | | | | | | | | | | | | | | |
| 86-2 | Example | 0.810 | 0.060 | 0.090 | 0.030 | 0.010 | 0.000 | 0.000 | 0.09 | 11.6 | 5.1 | 39% | 22.1 | 30% | A |
| 5-1 | Comparative | 0.790 | 0.060 | 0.090 | 0.030 | 0.030 | 0.000 | 0.000 | 0.00 | 11.5 | 8.9 | — | 14.6 | — | D |
| | Example | | | | | | | | | | | | | | |
| 5-2 | Example | 0.790 | 0.060 | 0.090 | 0.030 | 0.030 | 0.000 | 0.000 | 0.17 | 11.4 | 5.4 | 39% | 18.8 | 29% | A |
| 4-1 | Comparative | 0.770 | 0.060 | 0.090 | 0.030 | 0.050 | 0.000 | 0.000 | 0.00 | 11.4 | 10.9 | — | 11.9 | — | D |
| | Example | | | | | | | | | | | | | | |
| 4-2 | Example | 0.770 | 0.060 | 0.090 | 0.030 | 0.050 | 0.000 | 0.000 | 0.16 | 11.5 | 7.4 | 32% | 15.2 | 28% | A |
| 87-1 | Comparative | 0.745 | 0.060 | 0.090 | 0.030 | 0.075 | 0.000 | 0.000 | 0.00 | 11.8 | 10.9 | — | 11.9 | — | D |
| | Example | | | | | | | | | | | | | | |
| 87-2 | Example | 0.745 | 0.060 | 0.090 | 0.030 | 0.075 | 0.000 | 0.000 | 0.16 | 11.7 | 7.8 | 28% | 15.1 | 27% | A |
| 3-1 | Comparative | 0.720 | 0.060 | 0.090 | 0.030 | 0.100 | 0.000 | 0.000 | 0.00 | 12.0 | 11.6 | — | 9.8 | — | D |
| | Example | | | | | | | | | | | | | | |
| 3-2 | Example | 0.720 | 0.060 | 0.090 | 0.030 | 0.100 | 0.000 | 0.000 | 0.18 | 11.8 | 8.4 | 28% | 12.6 | 29% | A |
| 88-1 | Comparative | 0.700 | 0.060 | 0.090 | 0.030 | 0.120 | 0.000 | 0.000 | 0.00 | 11.7 | 12.5 | — | 8.7 | — | D |
| | Example | | | | | | | | | | | | | | |
| 88-2 | Example | 0.700 | 0.060 | 0.090 | 0.030 | 0.120 | 0.000 | 0.000 | 0.08 | 11.5 | 10.4 | 17% | 10.3 | 18% | B |
| 89-1 | Comparative | 0.670 | 0.060 | 0.090 | 0.030 | 0.150 | 0.000 | 0.000 | 0.00 | 12.1 | 13.6 | — | 7.8 | — | D |
| | Example | | | | | | | | | | | | | | |
| 89-2 | Example | 0.670 | 0.060 | 0.090 | 0.030 | 0.150 | 0.000 | 0.000 | 0.12 | 12.0 | 11.6 | 15% | 8.8 | 13% | B |
| 89a-1 | Comparative | 0.668 | 0.060 | 0.090 | 0.030 | 0.152 | 0.000 | 0.000 | 0.00 | 12.3 | 13.6 | — | 7.6 | — | D |
| | Example | | | | | | | | | | | | | | |
| 89a-2 | Example | 0.668 | 0.060 | 0.090 | 0.030 | 0.152 | 0.000 | 0.000 | 0.11 | 12.2 | 12.4 | 9% | 8.3 | 9% | B |
| 89b-1 | Comparative | 0.665 | 0.060 | 0.090 | 0.030 | 0.155 | 0.000 | 0.000 | 0.00 | 12.4 | 13.7 | — | 7.5 | — | D |
| | Example | | | | | | | | | | | | | | |
| 89b-2 | Example | 0.665 | 0.060 | 0.090 | 0.030 | 0.155 | 0.000 | 0.000 | 0.14 | 12.5 | 12.5 | 9% | 8.2 | 9% | B |
| 89c-1 | Comparative | 0.661 | 0.060 | 0.090 | 0.030 | 0.159 | 0.000 | 0.000 | 0.00 | 12.6 | 13.8 | — | 7.3 | — | D |
| | Example | | | | | | | | | | | | | | |
| 89c-2 | Example | 0.661 | 0.060 | 0.090 | 0.030 | 0.159 | 0.000 | 0.000 | 0.16 | 12.6 | 13.0 | 6% | 7.7 | 5% | C |
| 90-1 | Comparative | 0.660 | 0.060 | 0.090 | 0.030 | 0.160 | 0.000 | 0.000 | 0.00 | 12.8 | 14.1 | — | 7.1 | — | D |
| | Example | | | | | | | | | | | | | | |
| 90-2 | Comparative | 0.660 | 0.060 | 0.090 | 0.030 | 0.160 | 0.000 | 0.000 | 0.18 | 12.7 | 14.0 | 1% | 7.2 | 1% | D |
| | Example | | | | | | | | | | | | | | |

TABLE 7

| | | (Fe₁₋ₚ X1ₚ)_{Z} Mₐ B_{b} P_{c} Si_{d} Cₑ X2_{f} | | | | | | | | Crystal | | Coer- | Perme- | Perme- | |
|---|---|---|---|---|---|---|---|---|---|---|---|---|---|---|---|
| | Example/ | (p = 0, d = f = 0, M:Nb) | | | | | | | Around | Grain | Coer- | civity | ability | ability | |
| Sample | Comparative | Fe | M(Nb) | B | P | Si | C | X2 | 65º | Size | civity | Improve- | (×103) | Improve- | |
| No. | Example | Z | a | b | C | d | e | f | \|Δθ₁₂\| | (nm) | (A/m) | ment | [1kHz] | ment | Grade |
| 1-1 | Comparative | 0.820 | 0.060 | 0.090 | 0.030 | 0.000 | 0.000 | 0.000 | 0.00 | 11.3 | 7.3 | — | 18.2 | — | D |
| | Example | | | | | | | | | | | | | | |
| 1-8 | Example | 0.820 | 0.060 | 0.090 | 0.030 | 0.000 | 0.000 | 0.000 | 0.11 | 11.4 | 4.3 | 41% | 23.8 | 31% | A |
| 91-1 | Comparative | 0.815 | 0.060 | 0.090 | 0.030 | 0.000 | 0.005 | 0.000 | 0.00 | 11.5 | 10.9 | — | 14.1 | — | D |
| | Example | | | | | | | | | | | | | | |
| 91-2 | Example | 0.815 | 0.060 | 0.090 | 0.030 | 0.000 | 0.005 | 0.000 | 0.08 | 11.6 | 7.2 | 34% | 18.1 | 28% | A |
| 92-1 | Comparative | 0.810 | 0.060 | 0.090 | 0.030 | 0.000 | 0.010 | 0.000 | 0.00 | 11.4 | 14.2 | — | 12.7 | — | D |
| | Example | | | | | | | | | | | | | | |
| 92-2 | Example | 0.810 | 0.060 | 0.090 | 0.030 | 0.000 | 0.010 | 0.000 | 0.09 | 11.6 | 10.5 | 26% | 15.9 | 25% | A |
| 93-1 | Comparative | 0.800 | 0.060 | 0.090 | 0.030 | 0.000 | 0.020 | 0.000 | 0.00 | 11.6 | 16.6 | — | 10.9 | — | D |
| | Example | | | | | | | | | | | | | | |
| 93-2 | Example | 0.800 | 0.060 | 0.090 | 0.030 | 0.000 | 0.020 | 0.000 | 0.13 | 11.5 | 12.8 | 23% | 13.2 | 21% | A |
| 94-1 | Comparative | 0.795 | 0.060 | 0.090 | 0.030 | 0.000 | 0.025 | 0.000 | 0.00 | 11.5 | 16.8 | — | 10.9 | — | D |
| | Example | | | | | | | | | | | | | | |
| 94-2 | Example | 0.795 | 0.060 | 0.090 | 0.030 | 0.000 | 0.025 | 0.000 | 0.12 | 11.5 | 13.9 | 17% | 12.5 | 15% | B |
| 95-1 | Comparative | 0.790 | 0.060 | 0.090 | 0.030 | 0.000 | 0.030 | 0.000 | 0.00 | 11.7 | 17.1 | — | 9.8 | — | D |
| | Example | | | | | | | | | | | | | | |
| 95-2 | Example | 0.790 | 0.060 | 0.090 | 0.030 | 0.000 | 0.030 | 0.000 | 0.14 | 11.8 | 15.6 | 9% | 10.6 | 8% | C |
| 96-1 | Comparative | 0.780 | 0.060 | 0.090 | 0.030 | 0.000 | 0.040 | 0.000 | 0.00 | 12.3 | 18.2 | — | 8.6 | — | D |
| | Example | | | | | | | | | | | | | | |
| 96-2 | Comparative | 0.780 | 0.060 | 0.090 | 0.030 | 0.000 | 0.040 | 0.000 | 0.12 | 12.2 | 18.0 | 1% | 8.8 | 2% | D |
| | Example | | | | | | | | | | | | | | |

TABLE 8A

| | Ex- | | | | | | | | | | | | Coer- | | Perme- | |
|---|---|---|---|---|---|---|---|---|---|---|---|---|---|---|---|---|
| | ample/ | (Fe₁₋ₚ X1ₚ)_{Z} Mₐ B_{b} P_{c} Si_{d} Cₑ X2_{f} | | | | | | | | A- | Crystal | | civity | Perme- | ability | |
| Sam- | Com- | (p = 0, d = e = 0, M:Nb) | | | | | | | | round | Grain | Coer- | Im- | ability | Im- | |
| ple | parative | Fe | M (Nb) | B | P | Si | C | X2 | | 65° | Size | civity | prove- | (× 10³) | prove- | |
| No. | Example | Z | a | b | C | d | e | Type | f | \|Δθ₁₂\| | (nm) | (A/m) | ment | [1kHz] | ment | Grade |
| 1-1 | Com- | 0.820 | 0.060 | 0.090 | 0.030 | 0.000 | 0.000 | — | 0.000 | 0.00 | 11.3 | 7.3 | — | 18.2 | — | D |
| | parative | | | | | | | | | | | | | | | |
| | Example | | | | | | | | | | | | | | | |
| 1-8 | Example | 0.820 | 0.060 | 0.090 | 0.030 | 0.000 | 0.000 | — | 0.000 | 0.11 | 11.4 | 4.3 | 41% | 23.8 | 31% | A |
| 97-1 | Com- | 0.815 | 0.060 | 0.090 | 0.030 | 0.000 | 0.000 | Cr | 0.005 | 0.00 | 11.6 | 7.9 | — | 16.3 | — | D |
| | parative | | | | | | | | | | | | | | | |
| | Example | | | | | | | | | | | | | | | |
| 97-2 | Example | 0.815 | 0.060 | 0.090 | 0.030 | 0.000 | 0.000 | Cr | 0.005 | 0.10 | 11.5 | 5.2 | 34% | 20.8 | 28% | A |
| 98-1 | Com- | 0.805 | 0.060 | 0.090 | 0.030 | 0.000 | 0.000 | Cr | 0.015 | 0.00 | 11.5 | 8.6 | — | 14.8 | — | D |
| | parative | | | | | | | | | | | | | | | |
| | Example | | | | | | | | | | | | | | | |
| 98-2 | Example | 0.805 | 0.060 | 0.090 | 0.030 | 0.000 | 0.000 | Cr | 0.015 | 0.10 | 11.5 | 5.9 | 31% | 18.2 | 23% | A |
| 99-1 | Com- | 0.790 | 0.060 | 0.090 | 0.030 | 0.000 | 0.000 | Cr | 0.030 | 0.00 | 11.5 | 10.3 | — | 13.9 | — | D |
| | parative | | | | | | | | | | | | | | | |
| | Example | | | | | | | | | | | | | | | |
| 99-2 | Example | 0.790 | 0.060 | 0.090 | 0.030 | 0.000 | 0.000 | Cr | 0.030 | 0.07 | 11.7 | 7.9 | 23% | 17.0 | 22% | A |
| 100-1 | Com- | 0.780 | 0.060 | 0.090 | 0.030 | 0.000 | 0.000 | Cr | 0.040 | 0.00 | 11.8 | 11.6 | — | 12.7 | — | D |
| | parative | | | | | | | | | | | | | | | |
| | Example | | | | | | | | | | | | | | | |
| 100-2 | Com- | 0.780 | 0.060 | 0.090 | 0.030 | 0.000 | 0.000 | Cr | 0.040 | 0.17 | 11.7 | 11.4 | 2% | 12.8 | 1% | D |
| | parative | | | | | | | | | | | | | | | |
| | Example | | | | | | | | | | | | | | | |
| 101-1 | Com- | 0.815 | 0.060 | 0.090 | 0.030 | 0.000 | 0.000 | Cu | 0.005 | 0.00 | 10.5 | 7.3 | — | 17.4 | — | D |
| | parative | | | | | | | | | | | | | | | |
| | Example | | | | | | | | | | | | | | | |
| 101-2 | Example | 0.815 | 0.060 | 0.090 | 0.030 | 0.000 | 0.000 | Cu | 0.005 | 0.13 | 10.6 | 4.6 | 37% | 21.9 | 26% | A |
| 102-1 | Com- | 0.805 | 0.060 | 0.090 | 0.030 | 0.000 | 0.000 | Cu | 0.015 | 0.00 | 10.4 | 7.1 | — | 16.9 | — | D |
| | parative | | | | | | | | | | | | | | | |
| | Example | | | | | | | | | | | | | | | |
| 102-2 | Example | 0.805 | 0.060 | 0.090 | 0.030 | 0.000 | 0.000 | Cu | 0.015 | 0.15 | 10.3 | 4.4 | 38% | 21.0 | 24% | A |
| 103-1 | Com- | 0.790 | 0.060 | 0.090 | 0.030 | 0.000 | 0.000 | Cu | 0.030 | 0.00 | 9.8 | 9.7 | — | 15.5 | — | D |
| | parative | | | | | | | | | | | | | | | |
| | Example | | | | | | | | | | | | | | | |
| 103-2 | Example | 0.790 | 0.060 | 0.090 | 0.030 | 0.000 | 0.000 | Cu | 0.030 | 0.10 | 9.9 | 6.7 | 31% | 19.1 | 23% | A |
| 104-1 | Com- | 0.780 | 0.060 | 0.090 | 0.030 | 0.000 | 0.000 | Cu | 0.040 | 0.00 | 8.5 | 10.2 | — | 15.1 | — | D |
| | parative | | | | | | | | | | | | | | | |
| | Example | | | | | | | | | | | | | | | |
| 104-2 | Com- | 0.780 | 0.060 | 0.090 | 0.030 | 0.000 | 0.000 | Cu | 0.040 | 0.17 | 8.6 | 10.1 | 1% | 15.1 | 0% | D |
| | parative | | | | | | | | | | | | | | | |
| | Example | | | | | | | | | | | | | | | |
| 105-1 | Com- | 0.815 | 0.060 | 0.090 | 0.030 | 0.000 | 0.000 | Ag | 0.005 | 0.00 | 12.1 | 8.2 | — | 16.2 | — | D |
| | parative | | | | | | | | | | | | | | | |
| | Example | | | | | | | | | | | | | | | |
| 105-2 | Example | 0.815 | 0.060 | 0.090 | 0.030 | 0.000 | 0.000 | Ag | 0.005 | 0.10 | 12.2 | 5.8 | 29% | 20.7 | 28% | A |
| 106-1 | Com- | 0.805 | 0.060 | 0.090 | 0.030 | 0.000 | 0.000 | Ag | 0.015 | 0.00 | 12.2 | 11.3 | — | 15.2 | — | D |
| | parative | | | | | | | | | | | | | | | |
| | Example | | | | | | | | | | | | | | | |
| 106-2 | Example | 0.805 | 0.060 | 0.090 | 0.030 | 0.000 | 0.000 | Ag | 0.015 | 0.07 | 12.1 | 8.7 | 23% | 18.9 | 24% | A |
| 107-1 | Com- | 0.790 | 0.060 | 0.090 | 0.030 | 0.000 | 0.000 | Ag | 0.030 | 0.00 | 11.9 | 14.3 | — | 14.0 | — | D |
| | parative | | | | | | | | | | | | | | | |
| | Example | | | | | | | | | | | | | | | |
| 107-2 | Example | 0.790 | 0.060 | 0.090 | 0.030 | 0.000 | 0.000 | Ag | 0.030 | 0.07 | 12.0 | 11.4 | 20% | 17.1 | 22% | A |
| 108-1 | Com- | 0.780 | 0.060 | 0.090 | 0.030 | 0.000 | 0.000 | Ag | 0.040 | 0.00 | 12.4 | 16.6 | — | 12.9 | — | D |
| | parative | | | | | | | | | | | | | | | |
| | Example | | | | | | | | | | | | | | | |
| 108-2 | Com- | 0.780 | 0.060 | 0.090 | 0.030 | 0.000 | 0.000 | Ag | 0.040 | 0.18 | 12.5 | 16.6 | 0% | 13.0 | 1% | D |
| | parative | | | | | | | | | | | | | | | |
| | Example | | | | | | | | | | | | | | | |

TABLE 8B

| | Ex- | | | | | | | | | | | | Coer- | | Perme- | |
|---|---|---|---|---|---|---|---|---|---|---|---|---|---|---|---|---|
| | ample/ | (Fe₁₋ₚ X1ₚ)_{Z} Mₐ B_{b} P_{c} Si_{d} Cₑ X2_{f} | | | | | | | | A- | Crystal | | civity | Perme- | ability | |
| Sam- | Com- | (p = 0, d = e = 0, M:Nb) | | | | | | | | round | Grain | Coer- | Im- | ability | Im- | |
| ple | parative | Fe | M (Nb) | B | P | Si | C | X2 | | 65° | Size | civity | prove- | (× 10³) | prove- | |
| No. | Example | Z | a | b | c | d | e | Type | f | \|Δθ₁₂\| | (nm) | (A/m) | ment | [1 kHz] | ment | Grade |
| 109-1 | Com- | 0.815 | 0.060 | 0.090 | 0.030 | 0.000 | 0.000 | Sn | 0.005 | 0.00 | 11.9 | 9.2 | — | 15.8 | — | D |
| | parative | | | | | | | | | | | | | | | |
| | Example | | | | | | | | | | | | | | | |
| 109-2 | Example | 0.815 | 0.060 | 0.090 | 0.030 | 0.000 | 0.000 | Sn | 0.005 | 0.11 | 11.8 | 6.2 | 33% | 20.3 | 28% | A |
| 110-1 | Com- | 0.815 | 0.060 | 0.090 | 0.030 | 0.000 | 0.000 | As | 0.005 | 0.00 | 11.5 | 8.6 | | 16.0 | | D |
| | parative | | | | | | | | | | | | | | | |
| | Example | | | | | | | | | | | | | | | |
| 110-2 | Example | 0.815 | 0.060 | 0.090 | 0.030 | 0.000 | 0.000 | As | 0.005 | 0.04 | 11.6 | 5.8 | 33% | 20.4 | 28% | A |
| 111-1 | Com- | 0.815 | 0.060 | 0.090 | 0.030 | 0.000 | 0.000 | Sb | 0.005 | 0.00 | 11.7 | 8.5 | — | 14.9 | — | D |
| | parative | | | | | | | | | | | | | | | |
| | Example | | | | | | | | | | | | | | | |
| 111-2 | Example | 0.815 | 0.060 | 0.090 | 0.030 | 0.000 | 0.000 | Sb | 0.005 | 0.13 | 11.6 | 5.9 | 31% | 18.9 | 27% | A |
| 112-1 | Com- | 0.815 | 0.060 | 0.090 | 0.030 | 0.000 | 0.000 | A1 | 0.005 | 0.00 | 12.1 | 9.8 | — | 16.6 | — | D |
| | parative | | | | | | | | | | | | | | | |
| | Example | | | | | | | | | | | | | | | |
| 112-2 | Example | 0.815 | 0.060 | 0.090 | 0.030 | 0.000 | 0.000 | Al | 0.005 | 0.04 | 11.9 | 6.7 | 32% | 20.9 | 26% | A |
| 113-1 | Com- | 0.815 | 0.060 | 0.090 | 0.030 | 0.000 | 0.000 | Zn | 0.005 | 0.00 | 12.1 | 7.9 | — | 14.9 | — | 0 |
| | parative | | | | | | | | | | | | | | | |
| | Example | | | | | | | | | | | | | | | |
| 113-2 | Example | 0.815 | 0.060 | 0.090 | 0.030 | 0.000 | 0.000 | Zn | 0.005 | 0.08 | 11.9 | 5.2 | 34% | 19.0 | 28% | A |
| 114-1 | Com- | 0.815 | 0.060 | 0.090 | 0.030 | 0.000 | 0.000 | Bi | 0.005 | 0.00 | 11.5 | 7.9 | — | 16.6 | — | D |
| | parative | | | | | | | | | | | | | | | |
| | Example | | | | | | | | | | | | | | | |
| 114-2 | Example | 0.815 | 0.060 | 0.090 | 0.030 | 0.000 | 0.000 | Bi | 0.005 | 0.08 | 11.5 | 5.4 | 32% | 20.9 | 26% | A |
| 115-1 | Com- | 0.815 | 0.060 | 0.090 | 0.030 | 0.000 | 0.000 | S | 0.005 | 0.00 | 11.5 | 7.8 | — | 16.4 | — | D |
| | parative | | | | | | | | | | | | | | | |
| | Example | | | | | | | | | | | | | | | |
| 115-2 | Example | 0.815 | 0.060 | 0.090 | 0.030 | 0.000 | 0.000 | S | 0.005 | 0.02 | 11.6 | 4.6 | 41% | 21.3 | 30% | A |
| 116-1 | Com- | 0.815 | 0.060 | 0.090 | 0.030 | 0.000 | 0.000 | La | 0.005 | 0.00 | 11.6 | 7.4 | — | 16.5 | — | |
| | parative | | | | | | | | | | | | | | | |
| | Example | | | | | | | | | | | | | | | |
| 116-2 | Example | 0.815 | 0.060 | 0.090 | 0.030 | 0.000 | 0.000 | La | 0.005 | 0.06 | 11.5 | 4.9 | 34% | 21.0 | 27% | A |
| 117-1 | Com- | 0.815 | 0.060 | 0.090 | 0.030 | 0.000 | 0.000 | Y | 0.005 | 0.00 | 11.7 | 7.8 | — | 16.0 | — | D |
| | parative | | | | | | | | | | | | | | | |
| | Example | | | | | | | | | | | | | | | |
| 117-2 | Example | 0.815 | 0.060 | 0.090 | 0.030 | 0.000 | 0.000 | Y | 0.005 | 0.11 | 11.6 | 5.4 | 31% | 20.9 | 31% | A |

TABLE 8C

| | Example/ | (Fe₁₋ₚ X1ₚ)_{Z} Mₐ B_{b} P_{c} Si_{d} Cₑ X2_{f} | | | | | | | | A- | Crystal | | Coer- | Perme- | Perme- | |
|---|---|---|---|---|---|---|---|---|---|---|---|---|---|---|---|---|
| Sam- | Com- | (p = 0, d = e = 0, M:Nb) | | | | | | | | round | Grain | Coer- | civity | ability | ability | |
| ple | parative | Fe | M (Nb) | B | P | Si | C | X2 | | 65° | Size | civity | Improve- | (× 10³) | Improv- | |
| No. | Example | Z | a | b | C | d | e | Type | f | \|Δθ₁₂\| | (nm) | (A/m) | ment | [1 kHz] | ement | Grade |
| 118-1 | Com- | 0.819 | 0.060 | 0.090 | 0.030 | 0.000 | 0.000 | O | 0.001 | 0.00 | 12.0 | 8.8 | — | 16.6 | — | D |
| | parative | | | | | | | | | | | | | | | |
| | Example | | | | | | | | | | | | | | | |
| 118-2 | Example | 0.819 | 0.060 | 0.090 | 0.030 | 0.000 | 0.000 | O | 0.001 | 0.11 | 11.8 | 5.5 | 38% | 21.6 | 30% | A |
| 119-1 | Com- | 0.815 | 0.060 | 0.090 | 0.030 | 0.000 | 0.000 | O | 0.005 | 0.00 | 11.8 | 10.8 | — | 14.4 | — | D |
| | parative | | | | | | | | | | | | | | | |
| | Example | | | | | | | | | | | | | | | |
| 119-2 | Example | 0.815 | 0.060 | 0.090 | 0.030 | 0.000 | 0.000 | O | 0.005 | 0.08 | 11.9 | 7.7 | 29% | 17.8 | 24% | A |
| 120-1 | Com- | 0.805 | 0.060 | 0.090 | 0.030 | 0.000 | 0.000 | O | 0.015 | 0.00 | 11.9 | 13.3 | — | 13.7 | — | D |
| | parative | | | | | | | | | | | | | | | |
| | Example | | | | | | | | | | | | | | | |
| 120-2 | Example | 0.805 | 0.060 | 0.090 | 0.030 | 0.000 | 0.000 | O | 0.015 | 0.15 | 11.8 | 9.8 | 26% | 16.8 | 23% | A |
| 121-1 | Com- | 0.819 | 0.060 | 0.090 | 0.030 | 0.000 | 0.000 | N | 0.001 | 0.00 | 11.6 | 7.9 | — | 16.7 | — | D |
| | parative | | | | | | | | | | | | | | | |
| | Example | | | | | | | | | | | | | | | |
| 121-2 | Example | 0.819 | 0.060 | 0.090 | 0.030 | 0.000 | 0.000 | N | 0.001 | 0.05 | 11.6 | 5.2 | 34% | 21.2 | 27% | A |
| 122-1 | Com- | 0.815 | 0.060 | 0.090 | 0.030 | 0.000 | 0.000 | N | 0.005 | 0.00 | 11.5 | 11.9 | — | 14.1 | — | D |
| | parative | | | | | | | | | | | | | | | |
| | Example | | | | | | | | | | | | | | | |
| 122-2 | Example | 0.815 | 0.060 | 0.090 | 0.030 | 0.000 | 0.000 | N | 0.005 | 0.08 | 11.5 | 8.4 | 29% | 17.4 | 23% | A |
| 123-1 | Com- | 0.810 | 0.060 | 0.090 | 0.030 | 0.000 | 0.000 | N | 0.010 | 0.00 | 11.2 | 13.7 | — | 12.6 | — | D |
| | parative | | | | | | | | | | | | | | | |
| | Example | | | | | | | | | | | | | | | |
| 123-2 | Example | 0.810 | 0.060 | 0.090 | 0.030 | 0.000 | 0.000 | N | 0.010 | 0.10 | 11.2 | 10.2 | 26% | 15.3 | 21% | A |

TABLE 8D

| | Example/ | (Fe₁₋ₚ X1ₚ)_{Z} Mₐ B_{b} P_{c} Si_{d} Cₑ X2_{f} | | | | | | | | | | | | | | | | | | |
|---|---|---|---|---|---|---|---|---|---|---|---|---|---|---|---|---|---|---|---|---|
| | Com- | (p = 0, d = e = 0, f1 + f2 + f3 = f, M:Nb) | | | | | | | | | | | | Around | Crystal | | Coercivity | Permeability | | |
| Sample | parative | Fe | M (Nb) | B | P | Si | C | X2 | | | | | | 6.5° | Grain Size | Coercivity | Improve- | (× 10³) | Permeability | |
| No. | Example | Z | a | b | C | d | e | Type | fl | Type | f2 | Type | f3 | \|Δθ₁₂\| | (nm) | (A/m) | ment | [1 kHz] | Improvement | Grade |
| 124-1 | Com- | 0.810 | 0.060 | 0.090 | 0.030 | 0.000 | 0.000 | Cu | 0.005 | O | 0.005 | — | 0.000 | 0.00 | 10.1 | 7.3 | — | 17.8 | — | D |
| | parative | | | | | | | | | | | | | | | | | | | |
| | Example | | | | | | | | | | | | | | | | | | | |
| 124-2 | Example | 0.810 | 0.060 | 0.090 | 0.030 | 0.000 | 0.000 | Cu | 0.005 | O | 0.005 | | 0.000 | 0.09 | 10.2 | 4.5 | 38% | 22.9 | 29% | A |
| 125-1 | Com- | 0.810 | 0.060 | 0.090 | 0.030 | 0.000 | 0.000 | Cu | 0.005 | S | 0.005 | — | 0.000 | 0.00 | 9.7 | 7.8 | — | 17.6 | — | D |
| | parative | | | | | | | | | | | | | | | | | | | |
| | Example | | | | | | | | | | | | | | | | | | | |
| 125-2 | Example | 0.810 | 0.060 | 0.090 | 0.030 | 0.000 | 0.000 | Cu | 0.005 | S | 0.005 | — | 0.000 | 0.17 | 9.9 | 5.1 | 35% | 22.5 | 28% | A |
| 126-1 | Com- | 0.810 | 0.060 | 0.090 | 0.030 | 0.000 | 0.000 | Cu | 0.005 | Cr | 0.005 | — | 0.000 | 0.00 | 9.3 | 7.5 | — | 16.3 | — | D |
| | parative | | | | | | | | | | | | | | | | | | | |
| | Example | | | | | | | | | | | | | | | | | | | |
| 126-2 | Example | 0.810 | 0.060 | 0.090 | 0.030 | 0.000 | 0.000 | Cu | 0.005 | Cr | 0.005 | | 0.000 | 0.09 | 9.4 | 5.2 | 31% | 20.7 | 27% | A |
| 127-1 | Com- | 0.810 | 0.060 | 0.090 | 0.030 | 0.000 | 0.000 | Cr | 0.005 | S | 0.005 | — | 0.000 | 0.00 | 11.2 | 9.0 | — | 16.4 | — | D |
| | parative | | | | | | | | | | | | | | | | | | | |
| | Example | | | | | | | | | | | | | | | | | | | |
| 127-2 | Example | 0.810 | 0.060 | 0.090 | 0.030 | 0.000 | 0.000 | Cr | 0.005 | S | 0.005 | | 0.000 | 0.07 | 11.4 | 6.4 | 29% | 20.6 | 26% | A |
| 128-1 | Com- | 0.810 | 0.060 | 0.090 | 0.030 | 0.000 | 0.000 | Cr | 0.005 | O | 0.005 | — | 0.000 | 0.00 | 11.5 | 8.5 | — | 15.8 | — | D |
| | parative | | | | | | | | | | | | | | | | | | | |
| | Example | | | | | | | | | | | | | | | | | | | |
| 128-2 | Example | 0.810 | 0.060 | 0.090 | 0.030 | 0.000 | 0.000 | Cr | 0.005 | O | 0.005 | — | 0.000 | 0.10 | 11.4 | 5.7 | 33% | 19.7 | 25% | A |
| 129-1 | Com- | 0.810 | 0.060 | 0.090 | 0.030 | 0.000 | 0.000 | S | 0.005 | O | 0.005 | — | 0.000 | 0.00 | 11.6 | 8.2 | — | 16.6 | — | D |
| | parative | | | | | | | | | | | | | | | | | | | |
| | Example | | | | | | | | | | | | | | | | | | | |
| 129-2 | Example | 0.810 | 0.060 | 0.090 | 0.030 | 0.000 | 0.000 | S | 0.005 | O | 0.005 | — | 0.000 | 0.08 | 11.5 | 5.6 | 32% | 20.9 | 26% | A |
| 130-1 | Com- | 0.805 | 0.060 | 0.090 | 0.030 | 0.000 | 0.000 | Cu | 0.005 | Cr | 0.005 | S | 0.005 | 0.00 | 10.5 | 7.6 | | 16.1 | | D |
| | parative | | | | | | | | | | | | | | | | | | | |
| | Example | | | | | | | | | | | | | | | | | | | |
| 130-2 | Example | 0.805 | 0.060 | 0.090 | 0.030 | 0.000 | 0.000 | Cu | 0.005 | Cr | 0.005 | S | 0.005 | 0.15 | 10.7 | 4.9 | 36% | 21.1 | 31% | A |
| 131-1 | Com- | 0.805 | 0.060 | 0.090 | 0.030 | 0.000 | 0.000 | Cu | 0.005 | Cr | 0.005 | O | 0.005 | 0.00 | 10.4 | 7.9 | — | 15.6 | — | D |
| | parative | | | | | | | | | | | | | | | | | | | |
| | Example | | | | | | | | | | | | | | | | | | | |
| 131-2 | Example | 0.805 | 0.060 | 0.090 | 0.030 | 0.000 | 0.000 | Cu | 0.005 | Cr | 0.005 | O | 0.005 | 0.11 | 10.4 | 5.5 | 30% | 20.3 | 30% | A |
| 132-1 | Com- | 0.805 | 0.060 | 0.090 | 0.030 | 0.000 | 0.000 | Cr | 0.005 | S | 0.005 | O | 0.005 | 0.00 | 11.5 | 8.3 | — | 15.8 | — | D |
| | parative | | | | | | | | | | | | | | | | | | | |
| | Example | | | | | | | | | | | | | | | | | | | |
| 132-2 | Example | 0.805 | 0.060 | 0.090 | 0.030 | 0.000 | 0.000 | Cr | 0.005 | S | 0.005 | O | 0.005 | 0.08 | 11.6 | 5.8 | 30% | 20.2 | 28% | A |
| 133-1 | Com- | 0.805 | 0.060 | 0.090 | 0.030 | 0.000 | 0.000 | Cu | 0.005 | Cr | 0.005 | Al | 0.005 | 0.00 | 10.7 | 7.7 | — | 16.2 | — | D |
| | parative | | | | | | | | | | | | | | | | | | | |
| | Example | | | | | | | | | | | | | | | | | | | |
| 133-2 | Example | 0.805 | 0.060 | 0.090 | 0.030 | 0.000 | 0.000 | Cu | 0.005 | Cr | 0.005 | A1 | 0.005 | 0.13 | 10.6 | 5.3 | 31% | 21.0 | 30% | A |
| 134-1 | Com- | 0.805 | 0.060 | 0.090 | 0.030 | 0.000 | 0.000 | Cu | 0.005 | S | 0.005 | Sn | 0.005 | 0.00 | 10.4 | 8.1 | — | 16.0 | — | D |
| | parative | | | | | | | | | | | | | | | | | | | |
| | Example | | | | | | | | | | | | | | | | | | | |
| 134-2 | Example | 0.805 | 0.060 | 0.090 | 0.030 | 0.000 | 0.000 | Cu | 0.005 | S | 0.005 | Sn | 0.005 | 0.05 | 10.3 | 5.9 | 27% | 20.4 | 28% | A |
| 135-1 | Com- | 0.805 | 0.060 | 0.090 | 0.030 | 0.000 | 0.000 | Cr | 0.005 | O | 0.005 | Y | 0.005 | 0.00 | 11.3 | 8.9 | — | 16.1 | — | D |
| | parative | | | | | | | | | | | | | | | | | | | |
| | Example | | | | | | | | | | | | | | | | | | | |
| 135-2 | Example | 0.805 | 0.060 | 0.090 | 0.030 | 0.000 | 0.000 | Cr | 0.005 | O | 0.005 | Y | 0.005 | 0.08 | 11.5 | 6.6 | 26% | 20.1 | 25% | A |

As shown in Tables 2A to 8D, when the composition of the soft magnetic metal ribbon was within the specified range, examples in which one surface was polished using a grindstone roll having a grit number of 1600 or more exhibited superior magnetic properties compared with comparative examples prepared under the same conditions except that polishing was not performed. On the other hand, when the composition was outside the specified range, the magnetic properties were not sufficiently improved even when polishing was performed.

### Experimental Example 3

Experimental Example 3 was conducted for Sample Nos. 6-1 and 6-2 under the same conditions except that the average crystal grain size of Fe-based nanocrystals was changed by adjusting the heat treatment temperature and/or the heat treatment time. Results are shown in Table 9.

TABLE 9

| | Ex- | | | | | | | | | | | | | | | | |
|---|---|---|---|---|---|---|---|---|---|---|---|---|---|---|---|---|---|
| | ample/ | (Fe₁₋ₚ X1ₚ)_{Z} Mₐ Bₚ P_{c} Si_{d} Cₑ X2_{f} | | | | | | | Heat | | | | | | | | |
| | Com- | (p = 0, M:Nb) | | | | | | | Treatment | | | Crystal | | | Permeability | | |
| Sample | parative | Fe | M(Nb) | B | P | Si | C | X2 | Temperature | Time | Around 65º | Grain Size | Coercivity | Coercivity | (× 10³) | Permeability | |
| No. | Example | Z | a1 | b | C | d | e | f | (° C) | (h) | \|Δθ₁₂\| | (nm) | (A/m) | Improvement | [1 kHz] | Improvement | Grade |
| 6-3 | Com- | 0.840 | 0.040 | 0.090 | 0.030 | 0.000 | 0.000 | 0.000 | 450 | 0.5 | 0.00 | 3.0 | 21.1 | — | 7.2 | — | D |
| | parative | | | | | | | | | | | | | | | | |
| | Example | | | | | | | | | | | | | | | | |
| 6-4 | Example | 0.840 | 0.040 | 0.090 | 0.030 | 0.000 | 0.000 | 0.000 | 450 | 0.5 | 0.12 | 3.0 | 16.5 | 22% | 8.8 | 22% | A |
| 6-5 | Com- | 0.840 | 0.040 | 0.090 | 0.030 | 0.000 | 0.000 | 0.000 | 500 | 1 | 0.00 | 5.7 | 18.9 | — | 10.8 | — | D |
| | parative | | | | | | | | | | | | | | | | |
| | Example | | | | | | | | | | | | | | | | |
| 6-6 | Example | 0.840 | 0.040 | 0.090 | 0.030 | 0.000 | 0.000 | 0.000 | 500 | 1 | 0.10 | 5.8 | 13.9 | 26% | 13.4 | 24% | A |
| 6-1 | Com- | 0.840 | 0.040 | 0.090 | 0.030 | 0.000 | 0.000 | 0.000 | 550 | 1 | 0.00 | 9.4 | 13.8 | — | 15.9 | — | D |
| | parative | | | | | | | | | | | | | | | | |
| | Example | | | | | | | | | | | | | | | | |
| 6-2 | Example | 0.840 | 0.040 | 0.090 | 0.030 | 0.000 | 0.000 | 0.000 | 550 | 1 | 0.12 | 9.4 | 10.1 | 27% | 20.3 | 28% | A |
| 6-7 | Com- | 0.840 | 0.040 | 0.090 | 0.030 | 0.000 | 0.000 | 0.000 | 575 | 1 | 0.00 | 13.7 | 14.3 | — | 14.6 | — | D |
| | parative | | | | | | | | | | | | | | | | |
| | Example | | | | | | | | | | | | | | | | |
| 6-8 | Example | 0.840 | 0.040 | 0.090 | 0.030 | 0.000 | 0.000 | 0.000 | 575 | 1 | 0.13 | 13.5 | 10.7 | 25% | 18.6 | 27% | A |
| 6-9 | Com- | 0.840 | 0.040 | 0.090 | 0.030 | 0.000 | 0.000 | 0.000 | 600 | 1 | 0.00 | 26.4 | 22.8 | — | 7.2 | — | D |
| | parative | | | | | | | | | | | | | | | | |
| | Example | | | | | | | | | | | | | | | | |
| 6-10 | Example | 0.840 | 0.040 | 0.090 | 0.030 | 0.000 | 0.000 | 0.000 | 600 | 1 | 0.10 | 26.5 | 17.1 | 25% | 9.0 | 25% | A |
| 6-11 | Com- | 0.840 | 0.040 | 0.090 | 0.030 | 0.000 | 0.000 | 0.000 | 615 | 1 | 0.00 | 38.9 | 44.9 | — | 4.3 | — | D |
| | parative | | | | | | | | | | | | | | | | |
| | Example | | | | | | | | | | | | | | | | |
| 6-12 | Example | 0.840 | 0.040 | 0.090 | 0.030 | 0.000 | 0.000 | 0.000 | 615 | 1 | 0.11 | 38.6 | 34.1 | 24% | 5.3 | 23% | A |
| 6-13 | Com- | 0.840 | 0.040 | 0.090 | 0.030 | 0.000 | 0.000 | 0.000 | 615 | 3 | 0.00 | 50.0 | 58.3 | — | 3.9 | — | D |
| | parative | | | | | | | | | | | | | | | | |
| | Example | | | | | | | | | | | | | | | | |
| 6-14 | Example | 0.840 | 0.040 | 0.090 | 0.030 | 0.000 | 0.000 | 0.000 | 615 | 3 | 0.12 | 50.0 | 46.2 | 21% | 4.7 | 21% | A |
| 6-15 | Com- | 0.840 | 0.040 | 0.090 | 0.030 | 0.000 | 0.000 | 0.000 | 615 | 10 | 0.00 | 51.5 | 84.3 | — | 2.8 | — | D |
| | parative | | | | | | | | | | | | | | | | |
| | Example | | | | | | | | | | | | | | | | |
| 6-16 | Example | 0.840 | 0.040 | 0.090 | 0.030 | 0.000 | 0.000 | 0.000 | 615 | 10 | 0.14 | 51.3 | 69.4 | 18% | 3.2 | 14% | B |

Table 9 shows that the magnetic properties remained preferable even when the average crystal grain size of the Fe-based nanocrystals was changed. In addition, when the average crystal grain size of the Fe-based nanocrystals was 50.0 nm or less, particularly favorable magnetic properties were obtained.

### Experimental Example 4

Among the soft magnetic metal ribbons prepared in Experimental Example 1, those in which the free surface was polished were used to form wound cores.

The soft magnetic metal ribbon was wound so that the outermost surface, namely, the outer surface of the soft magnetic metal ribbon located at the outermost circumference of the wound portion corresponded to the surface shown in the table. Thus, a toroidal wound core as shown in FIG. 1 was formed. Specifically, the soft magnetic metal ribbon was wound such that the surface not shown in the table (i.e., the roll surface when the table denotes the free surface or the free surface when the table denotes the roll surface) was positioned on the inner side. The soft magnetic metal ribbon was heat treated after winding.

The wound core was formed so that its dimensions corresponded to those shown in the table. In particular, the size of a mandrel was adjusted so that the inner diameter corresponded to the value shown in the table. The number of windings of the soft magnetic metal ribbon was adjusted so that the outer diameter corresponded to the value shown in the table. The mandrel was removed after winding. The space factor of the wound core at an appropriately selected measurement position is expressed by the following equation (3), where N1 denotes the number of windings of the soft magnetic metal ribbon, t denotes the thickness of the soft magnetic metal ribbon, ID denotes the inner diameter of the wound portion, and OD denotes the outer diameter of the wound portion. For one wound core, the space factor was measured at four or more measurement positions that were appropriately selected, and the obtained values were averaged to calculate the space factor of the entire wound core. In this Experimental Example, the space factor of each wound core was 80%.

Space factor (%)=100×{(N1×t)/((OD−ID)/2)} (3)

The coercivity of the wound core was measured using an HC meter (K-HC1000, manufactured by Tohoku Steel Co., Ltd.). The inductance of the wound core was measured at a frequency of 1 kHz using an LCR meter (4284A, manufactured by Agilent Technologies) after a polyurethane-coated copper wire (UEW wire) was wound around the wound core. The permeability of the wound core was calculated from the inductance thereof. Results are shown in Table 10.

The X-ray diffraction pattern of the wound core was obtained in the same manner as that of the ribbon, using samples taken from portions including the outermost surface and samples taken from portions including the innermost surface.

TABLE 10

| | | | | | | Dimensions | | | Diffraction Peak Angle | | | | | | | | |
|---|---|---|---|---|---|---|---|---|---|---|---|---|---|---|---|---|---|
| | | Example/ | Ribbon | | | of Core | | | (Around 65°) (°) | | | | | | | | |
| | Ribbon | Com- | Surface Polishing | | | Outer | Inner | | Outermost | Innermost | Differ- | Crystal | | Coercivity | Permeability | Permeability | |
| Sample | Sample | parative | Polished | Grit | Outermost | Diameter | Diameter | Height | Surface | Surface | ence | Grain Size | Coercivity | Improve- | (× 10³) | Improve- | |
| No. | No. | Example | Surface | Number | Surface | (mm) | (mm) | (mm) | 2θ₃ | 2θ₄ | \|Δθ₃₄\| | (nm) | (A/m) | ment | [1 kHz] | ment | Grade |
| 201 | 1-1 | Com- | — | — | Free | 18 | 15 | 10 | 64.94 | 64.94 | 0.00 | 11.3 | 7.3 | — | 14.6 | — | D |
| | | parative | | | | | | | | | | | | | | | |
| | | Example | | | | | | | | | | | | | | | |
| 202 | 1-2 | Example | Free | 12000 | Free | 18 | 15 | 10 | 64.90 | 64.91 | 0.01 | 11.5 | 5.8 | 21% | 17.6 | 21% | A |
| 203 | | Example | Free | 12000 | Roll | 18 | 15 | 10 | 64.91 | 64.89 | 0.02 | 11.5 | 5.7 | 22% | 17.5 | 20% | A |
| 204 | 1-4 | Example | Free | 10000 | Free | 18 | 15 | 10 | 64.87 | 64.92 | 0.05 | 11.4 | 5.5 | 25% | 17.8 | 22% | A |
| 205 | | Example | Free | 10000 | Roll | 18 | 15 | 10 | 64.91 | 64.86 | 0.05 | 11.6 | 5.5 | 25% | 17.8 | 22% | A |
| 206 | 1-6 | Example | Free | 9000 | Free | 18 | 15 | 10 | 64.77 | 64.89 | 0.12 | 11.5 | 5.3 | 27% | 18.0 | 23% | A |
| 207 | | Example | Free | 9000 | Roll | 18 | 15 | 10 | 64.91 | 64.78 | 0.13 | 11.5 | 5.4 | 26% | 18.1 | 24% | A |
| 208 | 1-8 | Example | Free | 8000 | Free | 18 | 15 | 10 | 64.75 | 64.92 | 0.17 | 11.4 | 4.3 | 41% | 19.1 | 31% | A |
| 209 | | Example | Free | 8000 | Roll | 18 | 15 | 10 | 64.91 | 64.73 | 0.18 | 11.4 | 4.4 | 40% | 19.0 | 30% | A |
| 210 | 1-10 | Example | Free | 7500 | Free | 18 | 15 | 10 | 64.68 | 64.92 | 0.24 | 11.6 | 4.6 | 37% | 18.5 | 27% | A |
| 211 | | Example | Free | 7500 | Roll | 18 | 15 | 10 | 64.92 | 64.68 | 0.24 | 11.4 | 4.7 | 36% | 18.6 | 27% | A |
| 212 | 1-12 | Example | Free | 7000 | Free | 18 | 15 | 10 | 64.55 | 64.91 | 0.36 | 11.6 | 5.0 | 31% | 18.2 | 25% | A |
| 213 | | Example | Free | 7000 | Roll | 18 | 15 | 10 | 64.92 | 64.55 | 0.37 | 11.5 | 5.1 | 30% | 18.2 | 25% | A |
| 214 | 1-14 | Example | Free | 6000 | Free | 18 | 15 | 10 | 64.53 | 64.93 | 0.40 | 11.5 | 5.2 | 29% | 18.1 | 24% | A |
| 215 | | Example | Free | 6000 | Roll | 18 | 15 | 10 | 64.92 | 64.51 | 0.41 | 11.3 | 5.2 | 29% | 18.2 | 25% | A |
| 216 | 1-16 | Example | Free | 5000 | Free | 18 | 15 | 10 | 64.43 | 64.93 | 0.50 | 11.3 | 5.5 | 25% | 17.9 | 23% | A |
| 217 | | Example | Free | 5000 | Roll | 18 | 15 | 10 | 64.94 | 64.44 | 0.50 | 11.2 | 5.4 | 26% | 17.8 | 22% | A |
| 218 | 1-18 | Example | Free | 4000 | Free | 18 | 15 | 10 | 64.21 | 64.89 | 0.68 | 11.2 | 6.0 | 18% | 17.1 | 17% | B |
| 219 | | Example | Free | 4000 | Roll | 18 | 15 | 10 | 64.89 | 64.21 | 0.68 | 11.4 | 6.1 | 16% | 17.0 | 16% | B |
| 220 | 1-20 | Example | Free | 3000 | Free | 18 | 15 | 10 | 63.91 | 64.90 | 0.99 | 11.3 | 6.5 | 11% | 16.6 | 14% | B |
| 221 | | Example | Free | 3000 | Roll | 18 | 15 | 10 | 64.91 | 63.91 | 1.00 | 11.5 | 6.5 | 11% | 16.6 | 14% | B |
| 222 | 1-22 | Example | Free | 2400 | Free | 18 | 15 | 10 | 63.90 | 64.91 | 1.01 | 11.4 | 6.7 | 8% | 15.9 | 9% | C |
| 223 | | Example | Free | 2400 | Roll | 18 | 15 | 10 | 64.91 | 63.90 | 1.01 | 11.5 | 6.7 | 8% | 15.8 | 8% | C |
| 224 | 1-24 | Example | Free | 2200 | Free | 18 | 15 | 10 | 61.83 | 64.88 | 3.05 | 11.5 | 6.7 | 8% | 15.8 | 8% | C |
| 225 | | Example | Free | 2200 | Roll | 18 | 15 | 10 | 64.88 | 61.83 | 3.05 | 11.3 | 6.7 | 8% | 15.7 | 8% | |
| 226 | 1-26 | Example | Free | 2000 | Free | 18 | 15 | 10 | 61.02 | 65.02 | 4.00 | 11.5 | 6.8 | 7% | 15.7 | 8% | 0 |
| 227 | | Example | Free | 2000 | Roll | 18 | 15 | 10 | 65.02 | 61.02 | 4.00 | 11.4 | 6.8 | 7% | 15.6 | 7% | C |
| 228 | 1-28 | Example | Free | 1800 | Free | 18 | 15 | 10 | 61.03 | 65.04 | 4.01 | 11.5 | 6.8 | 7% | 15.6 | 7% | C |
| 229 | | Example | Free | 1800 | Roll | 18 | 15 | 10 | 65.03 | 61.02 | 4.01 | 11.4 | 6.8 | 7% | 15.6 | 7% | C |
| 230 | 1-30 | Example | Free | 1600 | Free | 18 | 15 | 10 | 60.11 | 65.01 | 4.90 | 11.6 | 6.8 | 7% | 15.5 | 6% | C |
| 231 | | Example | Free | 1600 | Roll | 18 | 15 | 10 | 65.02 | 60.12 | 4.90 | 11.6 | 6.9 | 5% | 15.4 | 5% | C |
| 232 | 1-32 | Com- | Free | 1500 | Free | 18 | 15 | 10 | 60.10 | 65.01 | 4.91 | 11.7 | 7.1 | 3% | 14.9 | 2% | D |
| | | parative | | | | | | | | | | | | | | | |
| | | Example | | | | | | | | | | | | | | | |
| 233 | | Com- | Free | 1500 | Roll | 18 | 15 | 10 | 65.01 | 60.10 | 4.91 | 11.6 | 7.2 | 2% | 14.8 | 1% | D |
| | | parative | | | | | | | | | | | | | | | |
| | | Example | | | | | | | | | | | | | | | |
| 234 | 1-1 | Com- | — | — | Free | 37 | 24 | 15 | 64.95 | 64.95 | 0.00 | 11.3 | 7.3 | — | 14.6 | — | D |
| | | parative | | | | | | | | | | | | | | | |
| | | Example | | | | | | | | | | | | | | | |
| 235 | 1-8 | Example | Free | 8000 | Free | 37 | 24 | 15 | 64.81 | 64.92 | 0.11 | 11.5 | 4.4 | 40% | 19.1 | 31% | A |
| 236 | 1-1 | Com- | — | — | Free | 46 | 27 | 25 | 64.94 | 64.94 | 0.00 | 11.3 | 7.3 | | 14.6 | | D |
| | | parative | | | | | | | | | | | | | | | |
| | | Example | | | | | | | | | | | | | | | |
| 237 | 1-8 | Example | Free | 8000 | Free | 46 | 27 | 25 | 64.81 | 64.92 | 0.11 | 11.5 | 4.3 | 41% | 19.0 | 30% | A |
| 238 | 2-1 | Com- | — | — | Free | 18 | 15 | 10 | 65.89 | 65.89 | 0.00 | 16.3 | 7.3 | — | 14.6 | — | D |
| | | parative | | | | | | | | | | | | | | | |
| | | Example | | | | | | | | | | | | | | | |
| 239 | 2-8 | Example | Free | 8000 | Free | 18 | 15 | 10 | 65.71 | 65.85 | 0.14 | 16.5 | 4.4 | 40% | 19.1 | 31% | A |
| 240 | 2-1 | Com- | — | — | Free | 37 | 24 | 15 | 65.88 | 65.88 | 0.00 | 16.3 | 3.2 | — | 57.8 | — | D |
| | | parative | | | | | | | | | | | | | | | |
| | | Example | | | | | | | | | | | | | | | |
| 241 | 2-8 | Example | Free | 8000 | Free | 37 | 24 | 15 | 65.72 | 65.85 | 0.13 | 16.1 | 1.3 | 59% | 71.7 | 24% | A |
| 242 | 2-1 | Com- | | | Free | 46 | 27 | 25 | 65.88 | 65.88 | 0.00 | 16.2 | 3.3 | — | 57.8 | — | D |
| | | parative | | | | | | | | | | | | | | | |
| | | Example | | | | | | | | | | | | | | | |
| 243 | 2-8 | Example | Free | 8000 | Free | 46 | 27 | 25 | 65.72 | 65.85 | 0.13 | 16.0 | 1.4 | 58% | 71.6 | 24% | A |

As shown in Table 10, the wound cores of the examples, in which the soft magnetic metal ribbon of the example was wound so that the angle difference in the diffraction pattern between the outermost surface and the innermost surface was within the specified range, exhibited preferable magnetic properties compared with the wound cores of the comparative examples, in which the soft magnetic metal ribbon of the comparative example was wound so that the angle difference in the diffraction pattern between the outermost surface and the innermost surface was outside the specified range.

### Experimental Example 5

Laminated cores having the same dimensions as Sample Nos. 201, 208, 234, and 235 of Experimental Example 4 were prepared using the soft magnetic metal ribbons of Sample Nos. 1-1 and 1-8.

First, the polished soft magnetic metal ribbon was punched into a toroidal shape having the outer diameter and the inner diameter shown in the table, and then subjected to heat treatment. Then, a double-sided tape including a PET substrate and an adhesive layer having a thickness of 5 μm was affixed to one surface of the soft magnetic metal ribbon. Thereafter, the PET substrate was removed to form an adhesive layer on one surface of the soft magnetic metal ribbon. The soft magnetic metal ribbons were laminated with the adhesive layers interposed therebetween until a height shown in the table was achieved.

The space factor of the laminated core at an appropriately selected measurement position is expressed by the following equation (4), where N2 denotes the number of laminated layers of the soft magnetic metal ribbons, t denotes the thickness of the soft magnetic metal ribbon, and T denotes the height of the laminated core. For one laminated core, the space factor was measured at four or more measurement positions that were appropriately selected, and the obtained values were averaged to calculate the space factor of the entire laminated core. In this Experimental Example, the space factor of each laminated core was 80%.

Space factor (%)=100×{(N2×t)/T} (4)

The properties of the laminated core were measured in the same manner as those of the wound core. Results are shown in Table 11.

TABLE 11

| | | | | Dimensions of Core | | | Crystal | | | Perme- | Perme- | |
|---|---|---|---|---|---|---|---|---|---|---|---|---|
| | Ribbon | Example/ | | Outer | Inner | | Grain | | Coercivity | ability | ability | |
| Sample | Sample | Comparative | Core | Diameter | Diameter | Height | Size | Coercivity | Improve- | (× 10³) | Improve- | |
| No. | No. | Example | Type | (mm) | (mm) | (mm) | (nm) | (A/m) | ment | [1 kHz] | ment | Grade |
| 201 | 1-1 | Comparative | Wound | 18 | 15 | 10 | 11.3 | 7.3 | — | 14.6 | — | D |
| | | Example | | | | | | | | | | |
| 208 | 1-8 | Example | | 18 | 15 | 10 | 11.4 | 4.3 | 41% | 19.1 | 31% | A |
| 301 | 1-1 | Comparative | Laminated | 18 | 15 | 10 | 11.3 | 7.4 | — | 14.6 | — | D |
| | | Example | | | | | | | | | | |
| 308 | 1-8 | Example | | 18 | 15 | 10 | 11.5 | 4.4 | 41% | 19.0 | 30% | A |
| 234 | 1-1 | Comparative | Wound | 37 | 24 | 15 | 11.4 | 7.3 | — | 14.6 | — | D |
| | | Example | | | | | | | | | | |
| 235 | 1-8 | Example | | 37 | 24 | 15 | 11.5 | 4.4 | 40% | 19.1 | 31% | A |
| 334 | 1-1 | Comparative | Laminated | 37 | 24 | 15 | 11.3 | 7.3 | — | 14.7 | — | D |
| | | Example | | | | | | | | | | |
| 335 | 1-8 | Example | | 37 | 24 | 15 | 11.4 | 4.5 | 38% | 19.0 | 29% | A |

As shown in Table 11, the laminated cores of the examples obtained by laminating the soft magnetic metal ribbons of the examples exhibited superior magnetic properties compared with the laminated cores of the comparative examples obtained by laminating the soft magnetic metal ribbons of the comparative examples.

### Experimental Example 6

Wound cores were prepared using a soft magnetic metal ribbon prepared in the same manner as Sample No. 1-1 except that the width was changed to 22 mm, or a soft magnetic metal ribbon prepared in the same manner as Sample No. 1-8 except that the width was changed to 22 mm and the free surface was polished.

The soft magnetic metal ribbon was wound so that the outermost surface, namely, the outer surface of the soft magnetic metal ribbon located at the outermost circumference of the wound portion, was the roll surface. Thus, an oval wound core having two arc segments as shown in FIG. 3 and a rounded rectangular wound core having four arc segments as shown in FIG. 2 were prepared. In this case, the soft magnetic metal ribbon was wound with the free surface on the inner side. The soft magnetic metal ribbon was heat treated after winding.

The wound core was formed so that its dimensions corresponded to those shown in the table. The size of a mandrel was adjusted so that the Lia and Lib corresponded to the values shown in the table. The number of windings was adjusted so that the Loa and Lob corresponded to the values shown in the table. The mandrel was removed after winding. The space factor of the wound core at an appropriately selected measurement position is expressed by the following equation (5), where N1 denotes the number of windings of the soft magnetic metal ribbon, t denotes the thickness of the soft magnetic metal ribbon, and D denotes the length from the outermost surface to the innermost surface of the wound portion. For one wound core, the space factor was measured at four or more measurement positions that were arbitrarily selected, and the obtained values were averaged to calculate the space factor of the entire wound core. In this Experimental Example, the space factor of each wound core was 80%.

Space factor (%)=100×{(N1×t)/D} (5)

The properties of the wound core of this Experimental Example were measured in the same manner as those of the wound core of Experimental Example 4. Results are shown in Table 12.

TABLE 12

| | | | | | | | | | Diffraction | | | | | | | |
|---|---|---|---|---|---|---|---|---|---|---|---|---|---|---|---|---|
| | | Example/ | | Dimensions of Core | | | | | Peak Angle | | | | | | | |
| | Ribbon | Com- | | Outer | | Inner | | | (Around 65°) (°) | | | | | Permeability | | |
| Sample | Sample | parative | Core | Loa | Lob | Lia | Lib | Height | Difference | Number of | Crystal Grain | Coercivity | Coercivity | (× 10³) | Permeability | |
| No. | No. | Example | Type | (mm) | (mm) | (mm) | (mm) | (mm) | \|Δθ₃₄\| | Arc Segments | Size (nm) | (A/m) | Improvement | [1 kHz] | Improvement | Grade |
| 401 | 1-1 | Com- | Wound | 17 | 48 | 10 | 41 | 22 | 0.00 | 2 | 11.5 | 7.3 | — | 14.6 | — | D |
| | | parative | | | | | | | | | | | | | | |
| | | Example | | | | | | | | | | | | | | |
| 402 | 1-8 | Example | | 17 | 48 | 10 | 41 | 22 | 0.18 | 2 | 11.5 | 4.3 | 41% | 19.0 | 30% | A |
| 403 | 1-1 | Com- | Wound | 22 | 64 | 12 | 54 | 22 | 0.00 | 2 | 11.3 | 7.3 | — | 14.6 | — | D |
| | | parative | | | | | | | | | | | | | | |
| | | Example | | | | | | | | | | | | | | |
| 404 | 1-8 | Example | | 22 | 64 | 12 | 54 | 22 | 0.17 | 2 | 11.2 | 4.4 | 40% | 19.1 | 31% | A |
| 405 | 1-1 | Com- | Wound | 28 | 80 | 16 | 68 | 22 | 0.00 | 2 | 11.4 | 7.3 | — | 14.6 | — | D |
| | | parative | | | | | | | | | | | | | | |
| | | Example | | | | | | | | | | | | | | |
| 406 | 1-8 | Example | | 28 | 80 | 16 | 68 | 22 | 0.17 | 2 | 11.3 | 4.2 | 42% | 19.0 | 30% | A |
| 407 | 1-1 | Com- | Wound | 34 | 96 | 19 | 81 | 22 | 0.00 | 2 | 11.5 | 7.3 | — | 14.6 | — | D |
| | | parative | | | | | | | | | | | | | | |
| | | Example | | | | | | | | | | | | | | |
| 408 | 1-8 | Example | | 34 | 96 | 19 | 81 | 22 | 0.17 | 2 | 11.6 | 4.3 | 41% | 19.1 | 31% | A |
| 409 | 1-1 | Com- | Wound | 13 | 48 | 6 | 41 | 22 | 0.00 | 4 | 11.4 | 7.3 | — | 14.6 | — | D |
| | | parative | | | | | | | | | | | | | | |
| | | Example | | | | | | | | | | | | | | |
| 410 | 1-8 | Example | | 13 | 48 | 6 | 41 | 22 | 0.17 | 4 | 11.5 | 4.2 | 42% | 19.2 | 32% | A |
| 411 | 1-1 | Com- | Wound | 18 | 64 | 8 | 54 | 22 | 0.00 | 4 | 11.3 | 7.3 | — | 14.6 | — | D |
| | | parative | | | | | | | | | | | | | | |
| | | Example | | | | | | | | | | | | | | |
| 412 | 1-8 | Example | | 18 | 64 | 8 | 54 | 22 | 0.18 | 4 | 11.5 | 4.2 | 42% | 19.1 | 31% | |
| 413 | 1-1 | Com- | Wound | 22 | 80 | 10 | 68 | 22 | 0.00 | 4 | 11.3 | 7.3 | — | 14.6 | — | D |
| | | parative | | | | | | | | | | | | | | |
| | | Example | | | | | | | | | | | | | | |
| 414 | 1-8 | Example | | 22 | 80 | 10 | 68 | 22 | 0.17 | 4 | 11.3 | 4.3 | 41% | 19.0 | 30% | A |
| 415 | 1-1 | Com- | Wound | 27 | 96 | 12 | 81 | 22 | 0.00 | 4 | 11.4 | 7.3 | — | 14.6 | — | D |
| | | parative | | | | | | | | | | | | | | |
| | | Example | | | | | | | | | | | | | | |
| 416 | 1-8 | Example | | 27 | 96 | 12 | 81 | 22 | 0.17 | 4 | 11.6 | 4.3 | 41% | 19.1 | 31% | A |

As shown in Table 12, the wound cores of the examples obtained by winding the soft magnetic metal ribbons of the examples exhibited superior magnetic properties compared with the wound cores of the comparative examples obtained by winding the soft magnetic metal ribbons of the comparative examples.

### Experimental Example 7

Wound cores were prepared in the same manner as Sample Nos. 413 and 414 of Experimental Example 6 except for the dimensions of the wound core. The dimensions of the wound core were changed so that the ratios Lob/Loa and Lib/Lia were constant in Sample Nos. 409 to 416 of Experimental Example 6, whereas the ratios Lob/Loa and Lib/Lia were varied in Experimental Example 7. Results are shown in Table 13.

TABLE 13

| | | | | | | | | | Diffraction | | | | | | | | | |
|---|---|---|---|---|---|---|---|---|---|---|---|---|---|---|---|---|---|---|
| | | | | | | | | | Peak | | | | | | | | | |
| | | | | | | | | | Angle | | | | | | | | | |
| | | Example/ | | | | | | | (Around | | | | | | | | | |
| | Ribbon | Com- | | Core Dimensions | | | | | 65°) (°) | Number | Crystal | | | Permeability | | | | |
| Sample | Sample | parative | Core | Outer Loa | Lob | Inner Lia | Lib | Height | Difference | of Arc | Grain Size | Coercivity | Coercivity | (× 10³) | Permeability | | Lob/ | Lib/ |
| No. | No. | Example | Type | (mm) | (mm) | (mm) | (mm) | (mm) | \|Δθ₃₄\| | Segments | (nm) | (A/m) | Improvement | [1 kHz] | Improvement | Grade | Loa | Lia |
| 417 | 1-1 | Com- | Wound | 42 | 42 | 29 | 29 | 22 | 0.00 | 4 | 11.5 | 7.3 | — | 14.6 | — | D | 1 | 1 |
| | | parative | | | | | | | | | | | | | | | | |
| | | Example | | | | | | | | | | | | | | | | |
| 418 | 1-8 | Example | | 42 | 42 | 29 | 29 | 22 | 0.18 | 4 | 11.5 | 4.2 | 42% | 19.1 | 31% | A | | |
| 419 | 1-1 | Com- | Wound | 27 | 57 | 14 | 44 | 22 | 0.00 | 4 | 11.3 | 7.3 | — | 14.6 | — | D | 2 | 3 |
| | | parative | | | | | | | | | | | | | | | | |
| | | Example | | | | | | | | | | | | | | | | |
| 420 | 1-8 | Example | | 27 | 57 | 14 | 44 | 22 | 0.18 | 4 | 11.2 | 4.4 | 40% | 19.0 | 30% | A | | |
| 413 | 1-1 | Com- | Wound | 22 | 80 | 10 | 68 | 22 | 0.00 | 4 | 11.3 | 7.3 | — | 14.6 | — | D | 4 | 7 |
| | | parative | | | | | | | | | | | | | | | | |
| | | Example | | | | | | | | | | | | | | | | |
| 414 | 1-8 | Example | | 22 | 80 | 10 | 68 | 22 | 0.17 | 4 | 11.3 | 4.3 | 41% | 19.0 | 30% | A | | |
| 421 | 1-1 | Com- | Wound | 16 | 81 | 10 | 75 | 22 | 0.00 | 4 | 11.4 | 7.3 | — | 14.6 | — | D | 5 | 8 |
| | | parative | | | | | | | | | | | | | | | | |
| | | Example | | | | | | | | | | | | | | | | |
| 422 | 1-8 | Example | | 16 | 81 | 10 | 75 | 22 | 0.18 | 4 | 11.3 | 4.4 | 40% | 19.2 | 32% | A | | |
| 423 | 1-1 | Com- | Wound | 17 | 121 | 8 | 112 | 22 | 0.00 | 4 | 11.3 | 7.3 | — | 14.6 | — | D | 7 | 14 |
| | | parative | | | | | | | | | | | | | | | | |
| | | Example | | | | | | | | | | | | | | | | |
| 424 | 1-8 | Example | | 17 | 121 | 8 | 112 | 22 | 0.17 | 4 | 11.5 | 4.3 | 41% | 19.1 | 31% | A | | |
| 425 | 1-1 | Com- | Wound | 13 | 127 | 6 | 120 | 22 | 0.00 | 4 | 11.3 | 7.3 | — | 14.6 | — | D | 10 | 20 |
| | | parative | | | | | | | | | | | | | | | | |
| | | Example | | | | | | | | | | | | | | | | |
| 426 | 1-8 | Example | | 13 | 127 | 6 | 120 | 22 | 0.17 | 4 | 11.3 | 4.4 | 40% | 19.1 | 31% | A | | |

As shown in Table 13, although the ratios Lib/Loa and Lob/Loa were changed, the wound cores of the examples obtained by winding the soft magnetic metal ribbons of the examples exhibited superior magnetic properties compared with the wound cores of the comparative examples obtained by winding the soft magnetic metal ribbons of the comparative examples.

### Experimental Example 8

Sample Nos. 427 to 432 were prepared in the same manner as Sample Nos. 419 and 420 except that the number of arc segments was changed while maintaining the inner circumferential length at the center of the wound core constant. The inner circumferential length at the center of the wound core refers to the length of a line located at a position equally distant from the outer circumferential surface and the inner circumferential surface of the wound core (dashed line shown in FIGS. 1 to 3). In addition, Sample Nos. 433 to 438 were prepared in the same manner as Sample Nos. 405 and 406 except that the number of arc segments was changed while maintaining the inner circumferential length at the center of the wound core constant.

When the number of arc segments is one, the shape is a toroidal shape as shown in FIG. 1. When the number of arc segments is two, the shape is an oval shape as shown in FIG. 3. When the number of arc segments is three, the shape is a rounded triangular shape. When the number of arc segments is four, the shape is a rounded rectangular shape as shown in FIG. 2.

In Experimental Example 8, the inner circumferential length at the center was calculated from the radius of curvature R of the arc segment and the length of a substantially straight portion.

The properties of the wound core of this Experimental Example were measured in the same manner as those of the wound core of Experimental Example 4. Results are shown in Table 14.

TABLE 14

| | | | | Inner | Diffraction | | | | | | | |
|---|---|---|---|---|---|---|---|---|---|---|---|---|
| | | | | Circum- | Peak Angle | | | | | | | |
| | | | | ferential | (Around | | Crystal | | Coer- | Perme- | Perme- | |
| | Ribbon | Example/ | | Length at | 65°) (°) | Number | Grain | Coer- | civity | ability | ability | |
| Sample | Sample | Comparative | Core | the Center | Difference | of Arc | Size | civity | Improve- | (× 10³) | Improve- | |
| No. | No. | Example | Type | (mm) | \|Δθ₃₄\| | Segments | (nm) | (A/m) | ment | [1 kHz] | ment | Grade |
| 427 | 1-1 | Comparative | Wound | 132 | 0.00 | 1 | 11.4 | 7.3 | — | 14.6 | — | D |
| | | Example | | | | | | | | | | |
| 428 | 1-8 | Example | | | 0.18 | 1 | 11.3 | 4.3 | 41% | 19.2 | 32% | A |
| 429 | 1-1 | Comparative | Wound | 132 | 0.00 | 2 | 11.4 | 7.3 | — | 14.6 | — | D |
| | | Example | | | | | | | | | | |
| 430 | 1-8 | Example | | | 0.18 | 2 | 11.3 | 4.3 | 41% | 19.2 | 32% | A |
| 431 | 1-1 | Comparative | Wound | 132 | 0.00 | 3 | 11.3 | 7.3 | — | 14.6 | — | D |
| | | Example | | | | | | | | | | |
| 432 | 1-8 | Example | | | 0.17 | 3 | 11.2 | 4.3 | 41% | 19.1 | 31% | A |
| 419 | 1-1 | Comparative | Wound | 133 | 0.00 | 4 | 11.3 | 7.3 | — | 14.6 | — | D |
| | | Example | | | | | | | | | | |
| 420 | 1-8 | Example | | | 0.18 | 4 | 11.2 | 4.4 | 40% | 19.0 | 30% | A |
| 433 | 1-1 | Comparative | Wound | 172 | 0.00 | 1 | 11.4 | 7.3 | — | 14.6 | — | D |
| | | Example | | | | | | | | | | |
| 434 | 1-8 | Example | | | 0.18 | 1 | 1.3 | 4.3 | 41% | 19.2 | 32% | A |
| 405 | 1-1 | Comparative | Wound | 173 | 0.00 | 2 | 11.4 | 7.3 | — | 14.6 | — | D |
| | | Example | | | | | | | | | | |
| 406 | 1-8 | Example | | | 0.17 | 2 | 11.3 | 4.2 | 42% | 19.0 | 30% | A |
| 435 | 1-1 | Comparative | Wound | 170 | 0.00 | 3 | 11.3 | 7.3 | — | 14.6 | — | D |
| | | Example | | | | | | | | | | |
| 436 | 1-8 | Example | | | 0.17 | 3 | 11.2 | 4.3 | 41% | 19.0 | 30% | A |
| 437 | 1-1 | Comparative | Wound | 171 | 0.00 | 4 | 11.3 | 7.3 | — | 14.6 | — | D |
| | | Example | | | | | | | | | | |
| 438 | 1-8 | Example | | | 0.17 | 4 | 11.3 | 4.3 | 41% | 19.0 | 30% | A |

As shown in Table 14, although their shape, in particular the number of arc segments, was changed, the wound cores of the examples obtained by winding the soft magnetic metal ribbons of the examples exhibited superior magnetic properties compared with the wound cores of the comparative examples obtained by winding the soft magnetic metal ribbons of the comparative examples.

### REFERENCE SIGNS LIST

1 . . . magnetic core (wound core, laminated core)
11 . . . outermost surface
13 . . . innermost surface
31 . . . nozzle
32 . . . molten metal
33 . . . roll
34 . . . soft magnetic metal ribbon
34a . . . free surface
34b . . . roll surface
35 . . . chamber

What is claimed is:

1. A soft magnetic metal ribbon comprising a main component represented by a composition formula (Fe₁₋ₚX1ₚ)_{1-(a+b+c+d+e+f)}MₐB_{b}P_{c}Si_{d}CₑX2_{f}, in atomic ratio, where
X1 comprises at least one selected from the group consisting of Co and Ni,
X2 comprises at least one selected from the group consisting of Al, Ag, Zn, Sn, As, Sb, Cu, Cr, Bi, S, O, N, and a rare earth element,
M comprises at least one selected from the group consisting of Nb, Hf, Zr, Ta, Ti, Mo, W, Mn, and V, and
0≤a≤0.100,
0.020≤b≤0.200,
0≤c≤0.100,
0≤d<0.160,
0≤e≤0.030,
0≤f≤0.030, and
0≤p≤0.500 are satisfied, wherein
the soft magnetic metal ribbon comprises an amorphous portion and a crystalline portion;
an angle of one peak selected from X-ray diffraction peaks derived from crystals on a first surface of the soft magnetic metal ribbon is defined as 2θ₁, the Miller indices of the peak are defined as (h1, k1, l1), and 60.00°≤2θ₁≤66.00° is satisfied;
an angle of one peak selected from X-ray diffraction peaks derived from crystals on a second surface of the soft magnetic metal ribbon located opposite to the first surface is defined as 2θ₂, the Miller indices of the peak are defined as (h2, k2, l2), and 60.00°≤2θ₂≤66.00° is satisfied; and
Δθ₁₂ is defined as 2θ₁−2θ₂, and 0.00°<|Δθ₁₂|≤4.90° and (h1, k1, l1)=(h2, k2, l2) are satisfied.

2. The soft magnetic metal ribbon according to claim 1, wherein 0≤d≤0.150 is satisfied.

3. The soft magnetic metal ribbon according to claim 1, further comprising Fe-based nanocrystals having an average crystal grain size of 50.0 nm or less.

4. A magnetic core having a wound portion comprising the soft magnetic metal ribbon according to claim 1.

5. A magnetic core having a laminated portion comprising the soft magnetic metal ribbon according to claim 1.

6. A magnetic core having a wound portion comprising a soft magnetic metal ribbon, the soft magnetic metal ribbon comprising a main component represented by a composition formula (Fe₁₋ₚX1ₚ)_{1-(a+b+c+d+e+f)}MₐB_{b}P_{c}Si_{d}CₑX2_{f}, in atomic ratio, where
X1 comprises at least one selected from the group consisting of Co and Ni,
X2 comprises at least one selected from the group consisting of Al, Ag, Zn, Sn, As, Sb, Cu, Cr, Bi, S, O, N, and a rare earth element,
M comprises at least one selected from the group consisting of Nb, Hf, Zr, Ta, Ti, Mo, W, Mn, and V, and
0≤a≤0.100,
0.020≤b≤0.200,
0≤c≤0.100,
0≤d<0.160,
0≤e≤0.030,
0≤f≤0.030, and
0≤p≤0.500 are satisfied, wherein
the wound portion includes an amorphous portion and a crystalline portion;
an angle of one peak selected from X-ray diffraction peaks derived from crystals on an outer surface of the soft magnetic metal ribbon located at the outermost surface of the wound portion is defined as 2θ₃, the Miller indices of the peak are defined as (h3, k3, l3), and 60.00°≤2θ₃≤66.00° is satisfied;
an angle of one peak selected from X-ray diffraction peaks derived from crystals on an inner surface of the soft magnetic metal ribbon located at the innermost surface of the wound portion is defined as 2θ₄, the Miller indices of the peak are defined as (h4, k4, l4), and 60.00°≤2θ₄≤66.00° is satisfied; and
Δθ₃₄ is defined as 2θ₃−2θ₄, and 0.00<|Δθ₃₄|≤4.90° and (h3, k3, l3)=(h4, k4, l4) are satisfied.

7. The magnetic core according to claim 6, wherein 0≤d≤0.150 is satisfied.

8. The magnetic core according to claim 6, wherein the soft magnetic metal ribbon comprises an amorphous portion and a crystalline portion;
an angle of one peak selected from X-ray diffraction peaks derived from crystals on a first surface of the soft magnetic metal ribbon is defined as 2θ₁, the Miller indices of the peak are defined as (h1, k1, l1), and 60.00°≤2θ₁≤66.00° is satisfied,
an angle of one peak selected from X-ray diffraction peaks derived from crystals on a second surface of the soft magnetic metal ribbon located opposite to the first surface is defined as 2θ₂, the Miller indices of the peak are defined as (h2, k2, l2), and 60.00°≤2θ₂≤66.00° is satisfied, and
Δθ₁₂ is defined as 2θ₁−2θ₂, and 0.00°<|Δθ₁₂|≤4.90° and (h1, k1, l1)=(h2, k2, l2) are satisfied.

9. The magnetic core according to claim 6, wherein the wound portion has a shape including two or more arc segments having centers different from each other.

10. The magnetic core according to claim 9, wherein the radii of the two or more arc segments are smaller than an equivalent circular diameter of a hollow portion of the wound portion.

11. A magnetic device comprising the soft magnetic metal ribbon according to claim 1.

12. A magnetic device comprising the magnetic core according to claim 6.
